(19) United States
(12) Patent Application Publication
(10) Pub. No.: US 2006/0185101 A1
(43) Pub. Date: Aug. 24, 2006

(54) Novel reactive yellow dye compounds and mixture thereof

(76) Inventors: Sung Yong Cho, Seoul (KR); Woo Jin Yoon, Seoul (KR); Jun Hyun Kim, Seoul (KR); Sung Il Myung, Seoul (KR)

Correspondence Address: CANTOR COLBURN, LLP, 55 GRIFFIN ROAD SOUTH, BLOOMFIELD, CT, 06002, US

(21) Appl. No.: 11/338,998

(22) Filed: Jan. 25, 2006

(30) Foreign Application Priority Data
Jan. 25, 2005 (KR) 10-2005-0006613

(51) Int. Cl. C09B 62/00

(52) U.S. Cl. 8/543

(57) ABSTRACT

Provided is a reactive dye mixture, comprising (i) one or more reactive dyes represented by Formula 1, and
(ii) one or more reactive dyes represented by Formula 2: 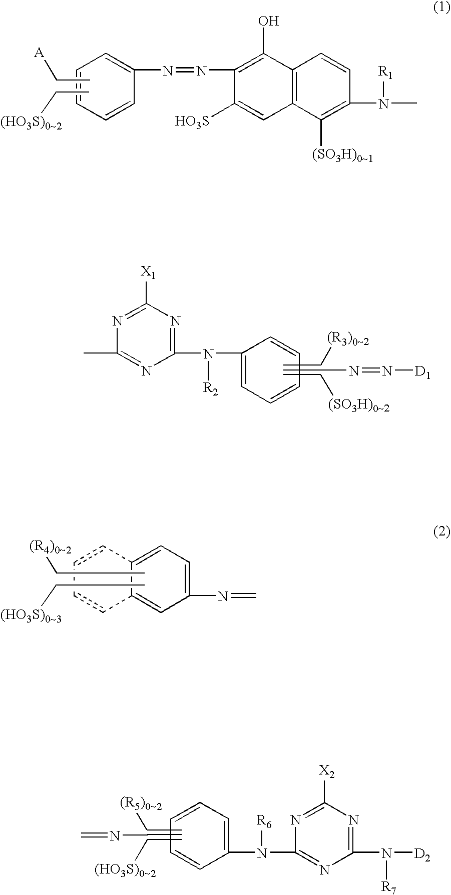 The dye mixture of the present invention can realize a color that is difficult to be achieved by a single dye when dyeing a fiber material containing nitrogen or hydroxyl group, particularly a cellulose fiber material, exhibits a superior absorptivity and fixability, particularly very high light fastness and wet fastness, and thus provides a variety of balanced physical properties which are required in dyeing.

### BACKGROUND OF THE INVENTION

1. Field of the Invention

The present invention relates to a reactive dye mixture, which is capable of realizing a color that is difficult to be achieved by a single dye when dyeing a fiber material containing nitrogen or hydroxyl group, particularly a cellulose fiber, which has a superior dyeability and a variety of superior fastness and which is capable of improving a dyeing process, and a method of combination dyeing using the same.

2. Description of the Related Art

As a conventional technique for yellow dyeing a cellulose fiber material using a reactive dye, a dyeing method using C.I. Reactive Yellow 145 compound which is a bifunctional reactive dye is generally used.

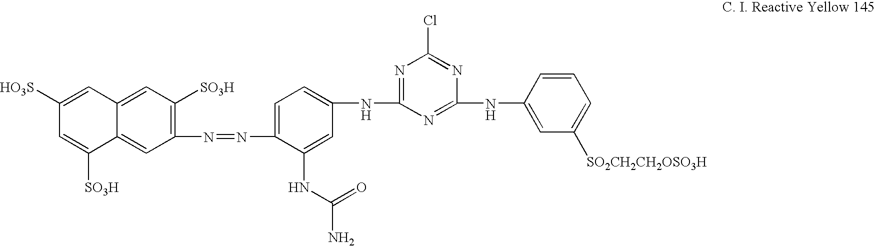

However, it is difficult to realize deep and various colors via dyeing using the above dye compound and thus a mixture of two or more dye compounds is often used. Such a mixed dye, for example a dye mixture of a red compound and a blue compound suffers from disadvantages such as a poor compatibility between both compounds, thus deteriorating reproducibility of desired colors and insufficient build-up properties, thus being unsatisfactory for high concentration dyeing. In addition, dyeing with a yellow dye alone, due to low build-up properties, is not suitable for high concentration dyeing. Similar to dyeing with any other dyes, yellow dyeing also requires high fastness against light or sweat, but fails to satisfy such requirements.

Meanwhile, dyeing using a reactive dye needs a more economical method in terms of qualities of dyed products and profitability of dyeing processes. Therefore, there is a need for a reactive dye which exhibits a high color yield upon performing high concentration dyeing, and at the same time, can be very easily freed from an unfixed dye by cleaning. Consequently, there is an urgent need for a novel reactive dye satisfying such requirements while exhibiting high fastness against light or washing.

### SUMMARY OF THE INVENTION

Therefore, the present invention has been made to solve the above problems, and other technical problems that have yet to be resolved.

As a result of a variety of extensive and intensive studies and experiments to solve the problems as described above, the inventors of the present invention have developed, as will be described hereinafter, a dye mixture having superior fastness against light and wet treatment upon dyeing a fiber material and has discovered that combination dyeing using the above-developed dye mixture enables reproduction of deep colors that are difficult to be achieved with use of a single dye and can significantly reduce an amount of an inorganic salt used in dyeing, thereby being capable of economically performing high-quality dyeing. The present invention has been completed based on these findings.

Specifically, it is an object of the present invention to provide a reactive dye mixture having a high color yield upon performing high concentration dyeing, and exhibiting superior light and wet fastness.

It is another object of the present invention to provide a method of dyeing a fiber material containing nitrogen or hydroxyl group, using the above-mentioned reactive dye mixture.

### BRIEF DESCRIPTION OF THE DRAWING

The above and other objects, features and other advantages of the present invention will be more clearly understood from the following detailed description taken in conjunction with the accompanying drawing, in which:

FIG. 1 is a graph showing build-up properties of a dye mixture in accordance with the present invention and a conventional dye, measured Experimental Example.

### DESCRIPTION OF THE PREFERRED EMBODIMENTS

In accordance with an aspect of the present invention, the above and other objects can be accomplished by the provision of a reactive dye mixture, comprising

(i) one or more reactive dyes represented by Formula 1; and

(ii) one or more reactive dyes represented by Formula 2:

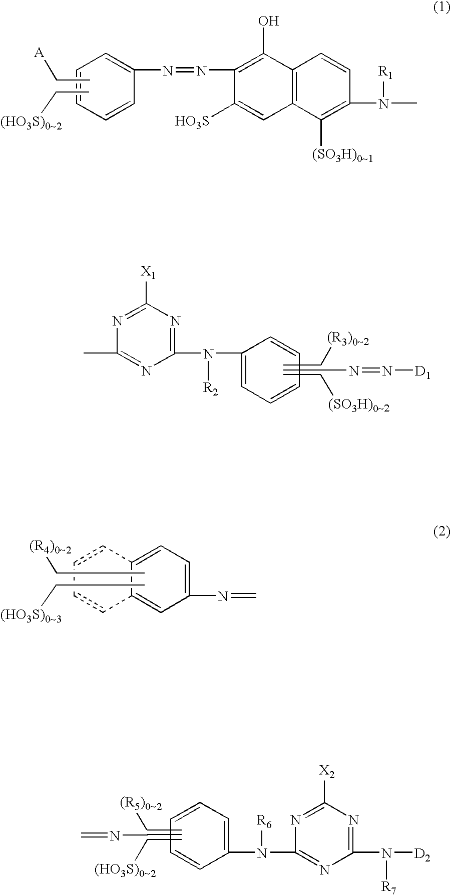

wherein:

R₁, R₂, R₆ and R₇ are independently hydrogen or C₁-C₄ alkyl, 2-hydroxyethyl, 2-chloroethyl or 2-fluoroethyl group;

R₃, R₄ and R₅ are independently hydrogen, sulfo, C₁-C₄alkyl, C₁-C₄alkoxy, hydroxyl, halogen, unsubstituted or C₁-C₄ alkyl substituted amino, phenylamino, acetylamino, C₂-C₄ alkanoylamino, benzoylamino, or ureido group;

A is a substituent group of 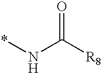
wherein R₈ is C₁-C₄ alkyl, unsubstituted or substituted phenyl, the substituted phenyl including nitro-substituted phenyl and cyano-substituted phenyl, or an amino group;

X₁ and X₂ are independently halogen, hydroxyl, unsubstituted or substituted amino, unsubstituted or C₁-C₄ alkyl substituted phenylamino, unsubstituted or carbamoyl or carboxy substituted pyridinyl, morpholino, or an N-heterocyclic group further containing a hetero atom;

D₁ is a substituent group of 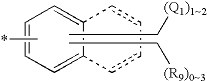
wherein R₉ is hydrogen, sulfo, C₁-C₄ alkyl, C₁-C₄ alkoxy, halogen, 2-hydroxyethyl, 2-chloroethyl, or 2-fluoroethyl group; and Q₁ is a radical of —SO₂-Z or —CONH—(CH₂)ᵣ—SO₂-Z, wherein Z is vinyl or a radical of —CH₂—CH₂—Y, Y being a leaving group (for example, —Cl, —Br, —F, —OSO₃H, —SSO₃H, —OCO—CH₃, —OPO₃H₂, —OCO—C₆H₅, —OSO₂—C₁-C₄alkyl, or —OSO₂—N(C₁-C₄alkyl)₂) and r is an integer from 1 to 6; and

D₂ is a substituent group of 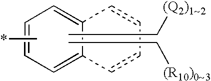
or *—(CH₂)_{1˜4}-Q₃ wherein R₁₀ is hydrogen, sulfo, C₁-C₄alkyl, C₁-C₄alkoxy, halogen, 2-hydroxyethyl, 2-chloroethyl or 2-fluoroethyl group; and Q₂ and Q₃ are independently a radical of —SO₂-Z or —CONH—(CH₂)ᵣ—SO₂-Z, wherein Z is vinyl or a radical of —CH₂—CH₂—Y, Y being a leaving group (for example, —Cl, —Br, —F, —OSO₃H, —SSO₃H, —OCO—CH₃, —OPO₃H₂, —OCO—C₆H₅, —OSO₂—C₁-C₄alkyl or —OSO₂—N(C₁-C₄alkyl)₂), and r is an integer from 1 to 6.

The dye mixture in accordance with the present invention may be preferably used to dye or print papers, plastic films, or fiber materials containing a hydroxyl group or a carboxyl amido group.

A mixing ratio of the dye of Formula 1: the dye of Formula 2 may be determined depending upon various factors such as kinds of compounds, kinds of desired colors and the like. Preferably, the dye mixture may contain 5 to 95% by weight of the dye of Formula 1, based on the total weight of the dye mixture. If necessary, the dye mixture may be a mixture containing both one or more dyes of Formula 1 and one or more dyes of Formula 2, and the mixing ratio therebetween is preferably as defined above.

The above compounds represented by a variety of Formulae can be prepared by those of ordinary skill in the art, based on chemical structures as described above. For example, in order to prepare the compounds represented by the above Formulae, diazotization, coupling, condensation or the like may be performed. Those skilled in the art can easily reproduce the preparation of such compounds with reference to the above Formulae.

In Formula 1, A may be preferably acetylamide or phenylamide of the structure as shown below:

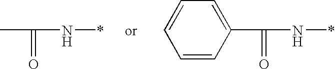

In Formulae 1 and 2, R₁, R₂, R₆ and R₇ may be particularly hydrogen.

In Formulae 1 and 2, X₁ and X₂ may be particularly fluorine or chlorine.

Further, in Formula 2, Y may be particularly preferably chlorine (—Cl) or sulfonic acid (—SO₃H).

Among the compounds of Formula 1, particularly preferred are the following compounds:

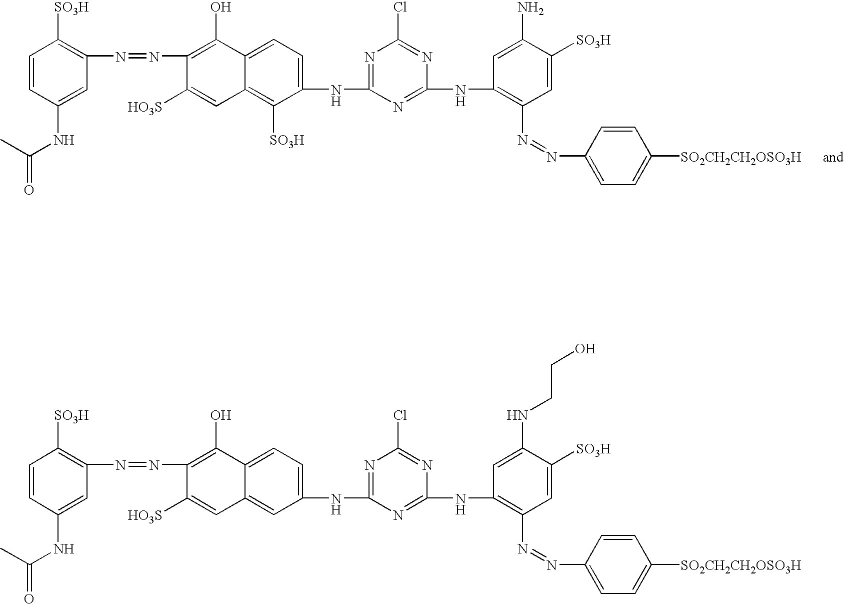

A preferred example of a reactive red dye of Formula 2 may include a compound represented by Formula 2a:

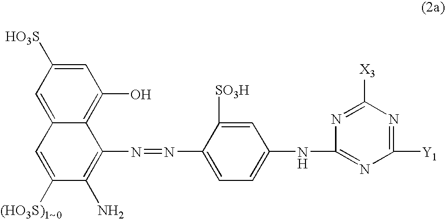

wherein:

X₃ is halogen, hydroxyl, 3-carboxypyridin-1-yl, 3-carbamoylpyridin-1-yl, C₁-C₄ alkoxy, C₁-C₄ alkylthio, unsubstituted or substituted amino, an N-heterocyclic group further containing a hetero atom, or the following substituent: 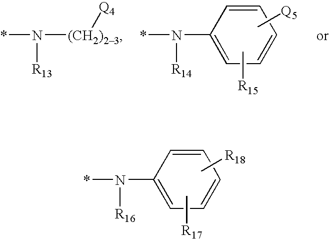
wherein R₁₃, R₁₄, R₁₅, R₁₆, R₁₇ and R₁₈ are as defined for R₃ in Formula 2, and Q₄ and Q₅ are as defined for Q₃ in Formulae 1 and 2; and

Y₁ is a substituent of 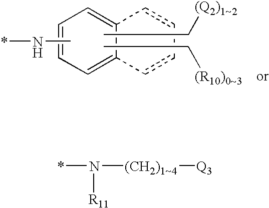
wherein Q₂, Q₃ and R₁₀ are as defined in Formula 2, and R₁₁ is hydrogen or a C₁-C₄alkyl group.

Among compounds of Formula 2, the particularly preferable compound may be the following compound:

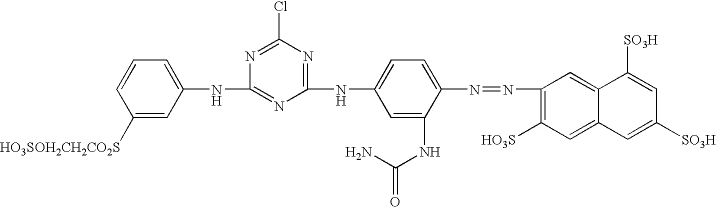

The reactive red dye of Formula 2a in accordance with the present invention may be prepared via reaction involving many steps of condensation, and a preferred example of such a method includes the following reaction steps:

(1) condensing a compound of the following Formula b with 2,4,6-trihalogeno-s-triazine, thereby preparing a compound of the following Formula c or d;

(2) condensing a compound of the following Formula c or d with a compound of the above Formula a-1, Formula a-2 or the following Formula b, thereby preparing a compound of the following Formula e; and

(3) condensing the compound of the following Formula e prepared in step (2) with the compound of Formula a-1, thereby preparing a compound of Formula a.

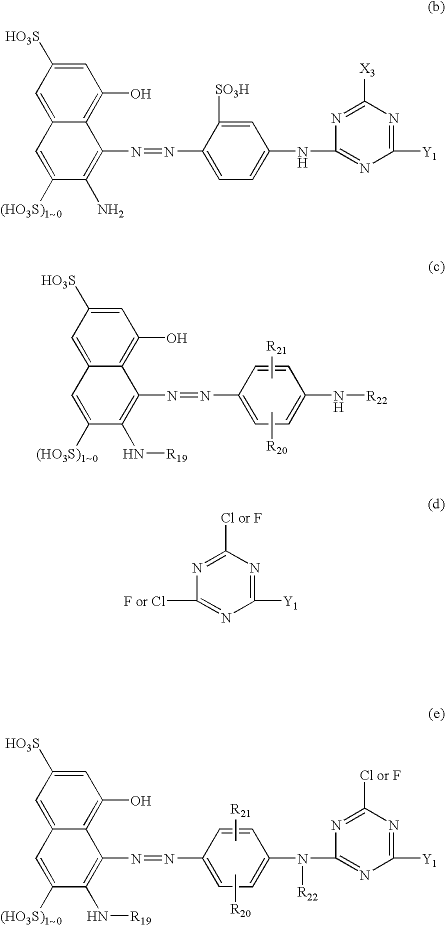

wherein:

R₁₉, R₂₀, R₂₁, and R₂₂ are as defined for R₃ in Formula 2; and

X₃ is as defined for Q₃ in Formulae 1 and 2.

Condensation (1) may be carried out in an organic medium, an aqueous medium, or an aqueous-organic medium, and is preferably carried out in the aqueous medium in the presence of an acid-binding agent. Preferred examples of the acid-binding agent may include carbonates, bicarbonates and hydroxides of alkali metals, carbonates, bicarbonates and hydroxides of alkaline earth metals, alkali metal acetates and mixtures thereof, and tertiary amines. Preferred examples of the alkali metals and alkaline earth metals may include lithium, sodium, potassium and calcium. Preferred examples of the tertiary amines may include pyridine, triethylamine and quinoline. Condensation (1) is carried out at a temperature of −10 to 40° C. and more preferably 0 to 10° C. and a pH of 1.0 to 9.0.

Similar to condensation (1), condensation (2) may also be carried out in an organic medium, an aqueous medium, or an aqueous-organic medium, and is preferably carried out in the aqueous medium in the presence of an acid-binding agent. Condensation (2) is carried out at a temperature of 10 to 70° C. and a pH of 2.0 to 9.0, and more preferably is carried out at a temperature of 20 to 60° C. and a pH of 2.0 to 8.0.

Further, similar to condensation (1), condensation (3) may also be carried out in an organic medium, an aqueous medium, or an aqueous-organic medium, and is preferably carried out in the aqueous medium in the presence of an acid-binding agent. Condensation (3) is carried out at a temperature of 50 to 100° C. and a pH of 1.0 to 9.0, and more preferably is carried out at a temperature of 20 to 60° C. and a pH of 2.0 to 5.0.

In accordance with another aspect of the present invention, there is provided a method of dyeing a fiber material, preferably a hydroxyl and/or carboxylamido-containing fiber material, more preferably a cellulose fiber material or a blended fiber material thereof, using the above-mentioned dye mixture. The dye mixture in accordance with the present invention is suitable as a dye for dyeing all types of cellulose fiber materials. The cellulose fiber material that can be used in the present invention includes, for example natural cellulose fibers such as cotton, flax and hemp, pulp and recycled cellulose. Particularly preferred is cotton. The dye mixture in accordance with the present invention is also suitable for dyeing a cellulose blended fabric, for example cotton/polyester, cotton/nylon blended fabric and the like.

An amount of a reactive dye to be used, such as the dye mixture of the present invention, may vary depending on a degree of desired coloration. For example, the reactive dye may be used in an amount of 0.01 to 10% by weight, and preferably 0.01 to 6% by weight, based on the fabric to be dyed.

When the dye mixture in accordance with the present invention is applied to the cellulose fiber by a conventional dip-dyeing or printing method, a yellow dyed product can be obtained.

The dip-dyeing method may use neutral salts such as sodium sulfate and sodium chloride, as an accelerating agent of dye uptake, and alkali agents such as sodium carbonate and sodium hydroxide, as an acid-binding agent assisting in binding between the cellulose fiber and dye.

The printing method may use a thickening agent which serves to attach the dye. Examples of the thickening agent include sodium alginate, starches, polyvinyl alcohol (PVA) and carboxylmethylcellulose (CMC). In the printing method, as a fixing agent that sets or fixes the dye via reaction between the dye and fiber, sodium bicarbonate and sodium carbonate may be used. In addition, urea may be used to enhance dissolution of dyes and level dyeing.

The dye mixture in accordance with the present invention is particularly suitable for dyeing via an exhaustion method. The exhaustion method of dyeing is usually carried out in an aqueous medium, at a reaction temperature of 20 to 105° C., preferably 30 to 90° C. and more preferably 40 to 80° C., using the dye and water in a weight ratio of 1:2 to 1:60 and preferably 1:5 to 1:20.

Alternatively, other suitable dyeing methods such as pad dyeing may be used. In pad dyeing, a fabric is typically impregnated and reacted in an aqueous solution, saline or a salt solution. Here, the pick-up rate is in a range of 20 to 150%, preferably 40 to 120%, and more preferably 50 to 100%, based on the weight of the fiber material to be dyed. The aqueous solution may contain a fixing alkali in advance, or if necessary, the fiber material may be treated with the fixing alkali after impregnation. Examples of suitable alkali metals include sodium carbonate, sodium bicarbonate, sodium hydroxide, disodium phosphate, trisodium phosphate, sodium borate, aqueous ammonia, sodium trichloroacetate, sodium silicate, and a mixture thereof. Among these compounds, an alkali hydroxide and/or alkali carbonate, particularly sodium hydroxide and/or sodium carbonate are preferred.

Fixation of the dye may be carried out, for example by steam-treating the impregnated fiber material at a temperature of 100 to 120° C. for example, particularly via thermal action such as by saturated steam. According to so-called cold pad-batch method, the dye and alkali metal are introduced to a padder, and they are stored and fixed at room temperature for several hours, for example 3 to 40 hours. After fixation, if desired, a dispersant is added to the resulting dyed product, followed by thorough rinsing.

The dyed product obtained according to the present invention exhibits bright color and high-color sharpness, and superior build-up and levelness properties. In addition, the dyed product exhibits high fixability of the dye, capability to easily wash and remove the non-fixed dye, and a small difference between adsorptivity and fixability, that is, a low loss of soap. Further, the dyed product obtained exhibits a high degree of coloration, high stability of fiber-dye bonding, superior fastness against washing, brine, cross-dyeing and sweating, and high fastness against wrinkles, ironing and friction, and particularly superior light fastness.

### EXAMPLES

Now, the present invention will be described in more detail with reference to the following Examples and Preparative Examples. These examples are provided only for illustrating the present invention and should not be construed as limiting the scope and sprit of the present invention. In the following examples, all parts and percentages are by weight unless otherwise specified, and parts by weight versus parts by volume is in the relationship of kg versus liter (L).

### Preparative Example 1

239.3 parts of 2-amino-naphthol-7-sulfonic acid were dispersed in 2000 parts of water and then the resulting dispersion was neutralized to pH 7 using a 25% aqueous solution of sodium hydroxide. 184.4 parts of cyanuric chloride were dispersed in 300 parts of water at 0° C. and the 2-amino-naphthol-7-sulfonic acid solution was added dropwise thereto for 1 hour. The resulting solution was neutralized to pH 3.0 with a 20% aqueous solution of sodium carbonate, thereby preparing a first condensation product.

23.12 parts of (4-N-acetyl)-2,4-phenylenediamine sulfonic acid were dispersed in 50 parts of water, and 156.4 parts of 35% hydrochloric acid was added thereto. Then, 230 parts of 30% sodium nitrite solution was added dropwise to the resulting solution for 30 min while maintaining below 5° C. and the mixture was maintained at that temperature for 2 hours, thereby synthesizing a diazonium salt of (4-N-acetyl)-2,4-phenylenediamine sulfonic acid.

The thus-obtained (4-N-acetyl)-2,4-phenylenediamine sulfonic acid diazonium salt was added to the first condensation product and the resulting mixture was neutralized to pH 7 with a 20% aqueous solution of sodium carbonate while maintaining below 10° C., thereby preparing a first coupling product.

232.3 parts of (2-N-2-hydroxyethyl)-2,4-phenylenediamine sulfonic acid in the form of powder was added to the first coupling product which was then neutralized to pH 7 with a 20% aqueous solution of sodium carbonate, thereby preparing a second condensation product.

500 parts of water and 156.4 parts of 35% hydrochloric acid were added to 281.3 parts of 4-aminobenzene-sulfatoethyl sulfonic acid, and 230 parts of a 30% sodium nitrite solution was added dropwise to the resulting solution for 30 min while maintaining below 5° C. The mixture was maintained at that temperature for 2 hours, thereby synthesizing a diazonium salt of 4-aminobenzene-sulfatoethyl sulfonic acid.

The thus-synthesized second condensation product and 4-aminobenzene-sulfatoethyl sulfonic acid diazonium salt were mixed, and the resulting mixture was neutralized to pH 7 with a 20% aqueous solution of sodium carbonate while maintaining below 10° C., thereby preparing a compound having the structure as shown below:

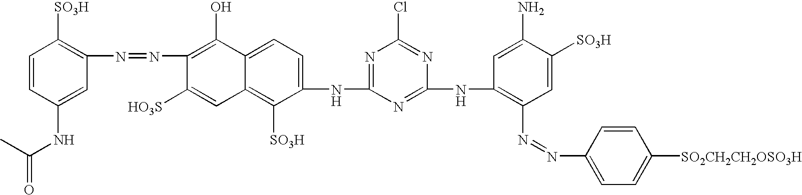

### Preparative Example 2

319.3 parts of 2-amino-naphthol-1,7-disulfonic acid were dispersed in 1500 parts of water and then the resulting dispersion was neutralized to pH 7 using a 25% aqueous solution of sodium hydroxide. 184.4 parts of cyanuric chloride were dispersed in 300 parts of water at 0° C. and the 2-amino-naphthol-7-sulfonic acid solution was added dropwise thereto for 1 hour. The resulting solution was neutralized to pH 3.0 with a 20% aqueous solution of sodium carbonate, thereby preparing a first condensation product.

23.12 parts of (4-N-acetyl)-2,4-phenylenediamine sulfonic acid were dispersed in 50 parts of water, and 156.4 parts of 35% hydrochloric acid was added thereto. Then, 230 parts of 30% sodium nitrite solution was added dropwise to the resulting solution for 30 min while maintaining below 5° C., and the mixture was maintained at that temperature for 2 hours, thereby synthesizing a diazonium salt of (4-N-acetyl)-2,4-phenylenediamine sulfonic acid.

The thus-obtained (4-N-acetyl)-2,4-phenylenediamine sulfonic acid diazonium salt was added to the first condensation product and the resulting mixture was neutralized to pH 7 with a 20% aqueous solution of sodium carbonate while maintaining below 10° C., thereby preparing a first coupling product.

188.2 parts of 2,4-phenylenediamine sulfonic acid in the form of powder was added to the first coupling product which was then neutralized to pH 7 with a 20% aqueous solution of sodium carbonate, thereby preparing a second condensation product.

500 parts of water and 156.4 parts of 35% hydrochloric acid were added to 281.3 parts of 4-aminobenzene-sulfatoethyl sulfonic acid, and 230 parts of a 30% sodium nitrite solution was added dropwise to the resulting solution for 30 min while maintaining below 5° C. The mixture was maintained at that temperature for 2 hours, thereby synthesizing a diazonium salt of 4-aminobenzene-sulfatoethyl sulfonic acid.

The thus-synthesized second condensation product and 4-aminobenzene-sulfatoethyl sulfonic acid diazonium salt were mixed, and the resulting mixture was neutralized to pH 7 with a 20% aqueous solution of sodium carbonate while maintaining below 10° C., thereby preparing a compound having the structure as shown below:

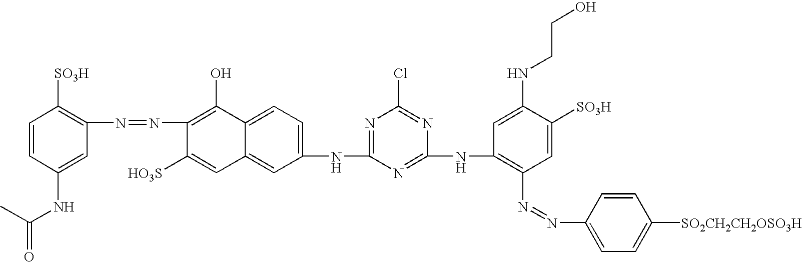

### Preparative Examples 3 Through 86

Based on procedures in Preparative Examples 1 and 2, it was possible to synthesize compounds listed in Table 1. A specific preparation method of these compounds can be sufficiently deduced through Preparative Examples 1 and 2 based on chemical structures of the products, and thus details thereof will be omitted herein.

Compound of Formula 1

TABLE 1

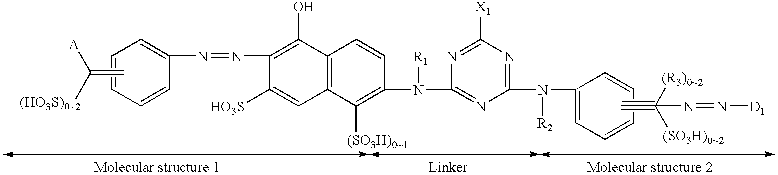

| | | Linker | | |
|---|---|---|---|---|
| No. | Molecular structure 1 | (X₁) | Molecular structure 2 | Color |
| Prep. Ex. 3 | 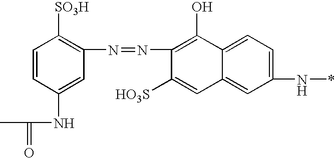 | Cl | 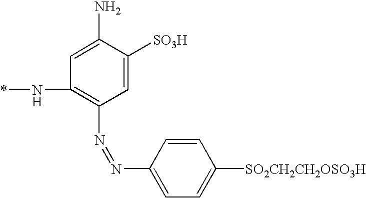 | Orange |
| Prep. Ex. 4 | 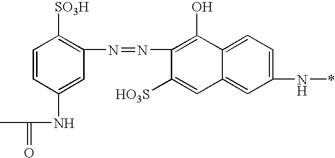 | Cl | 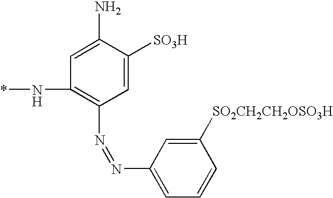 | Orange |
| Prep. Ex. 5 | 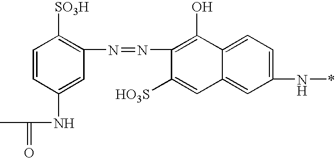 | Cl | 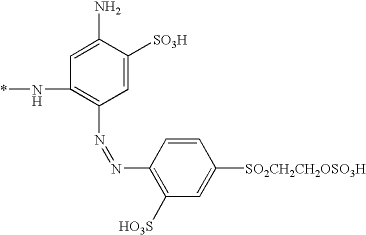 | Orange |
| Prep. Ex. 6 | 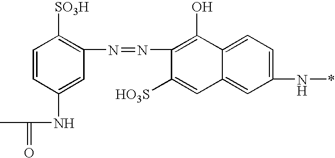 | Cl | 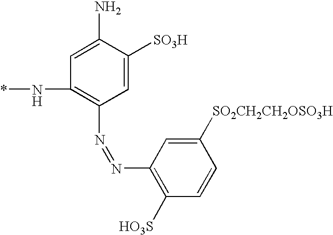 | Orange |
| Prep. Ex. 7 | 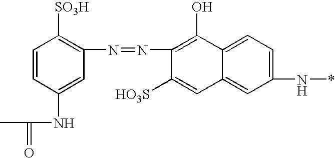 | Cl | 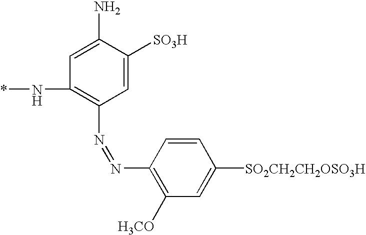 | Orange |
| Prep. Ex. 8 | 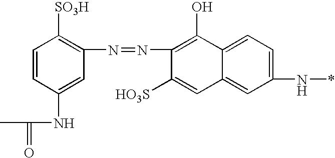 | Cl | 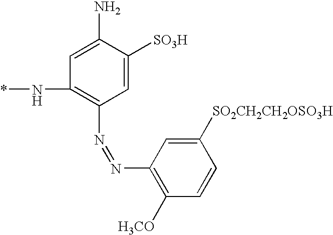 | Orange |
| Prep. Ex. 9 | 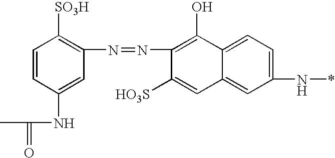 | Cl | 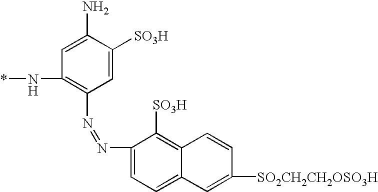 | Orange |
| Prep. Ex. 10 | 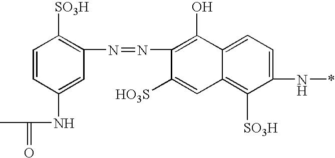 | Cl | 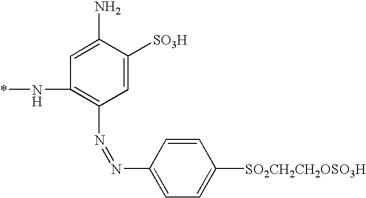 | Orange |
| Prep. Ex. 11 | 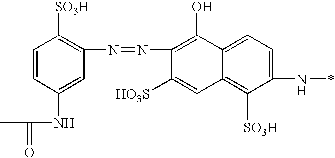 | Cl | 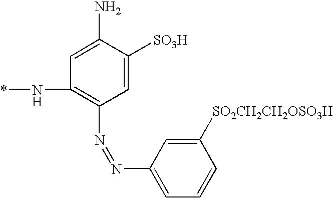 | Orange |
| Prep. Ex. 12 | 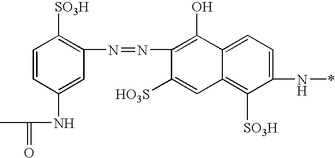 | Cl | 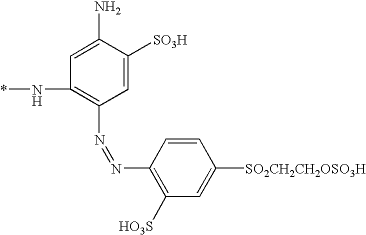 | Orange |
| Prep. Ex. 13 | 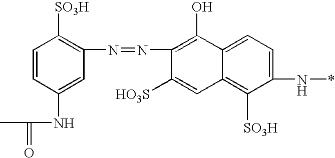 | Cl | 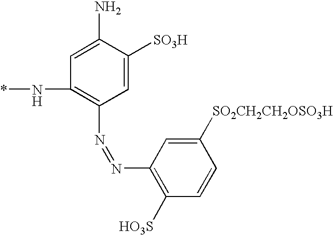 | Orange |
| Prep. Ex. 14 | 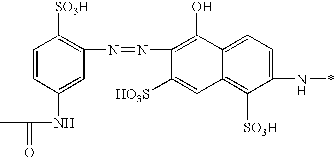 | Cl | 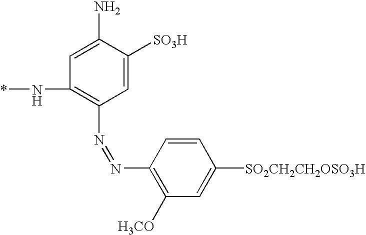 | Orange |
| Prep. Ex. 15 | 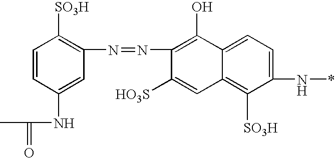 | Cl | 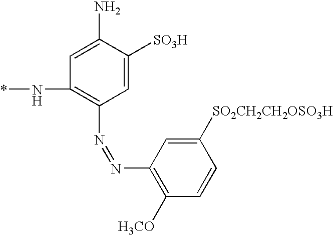 | Orange |
| Prep. Ex. 16 | 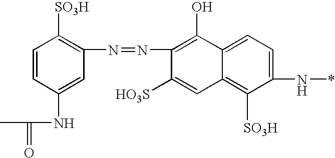 | Cl | 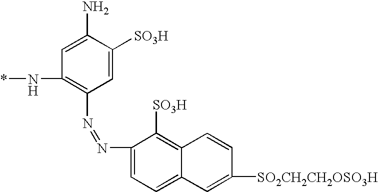 | Orange |
| Prep. Ex. 17 | 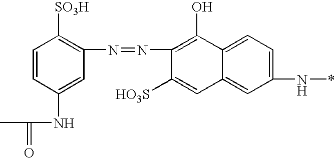 | F | 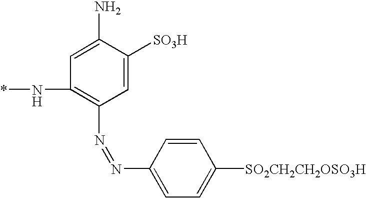 | Orange |
| Prep. Ex. 18 | 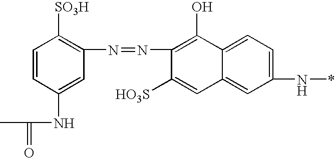 | F | 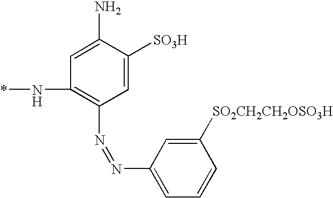 | Orange |
| Prep. Ex. 19 | 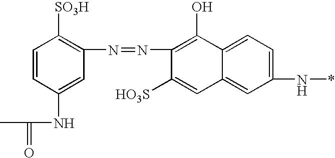 | F | 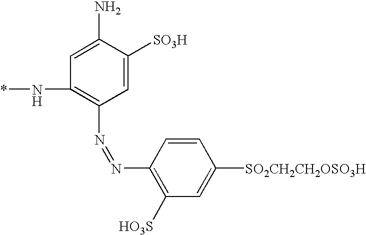 | Orange |
| Prep. Ex. 20 | 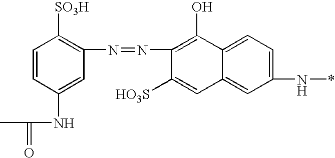 | F | 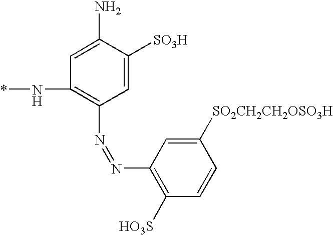 | Orange |
| Prep. Ex. 21 | 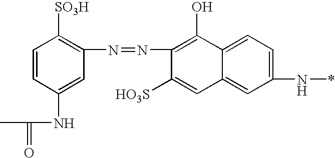 | F | 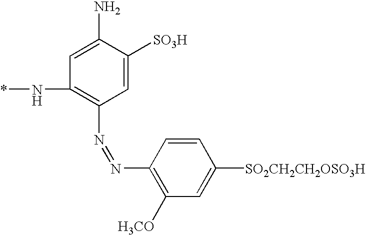 | Orange |
| Prep. Ex. 22 | 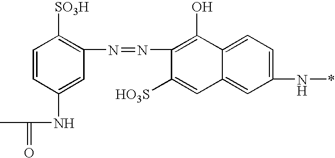 | F | 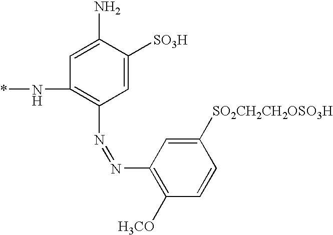 | Orange |
| Prep. Ex. 23 | 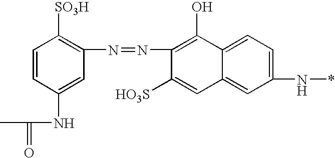 | F | 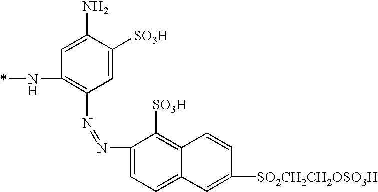 | Orange |
| Prep. Ex. 24 | 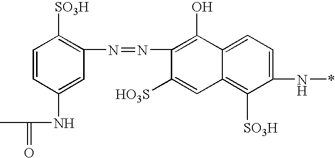 | F | 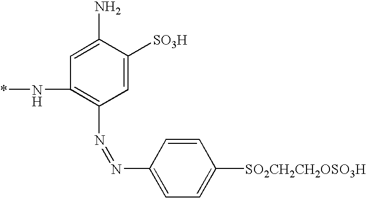 | Orange |
| Prep. Ex. 25 | 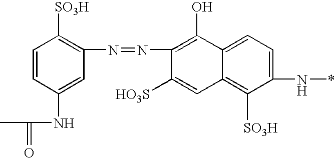 | F | 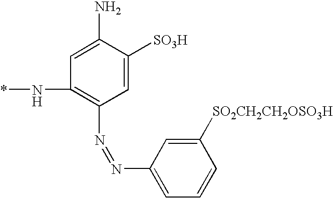 | Orange |
| Prep. Ex. 26 | 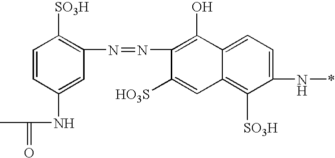 | F | 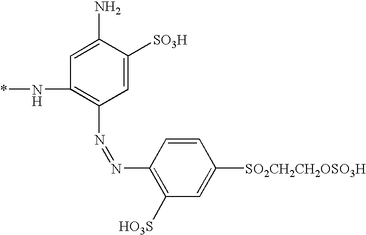 | Orange |
| Prep. Ex. 27 | 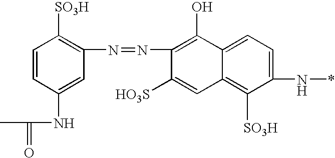 | F | 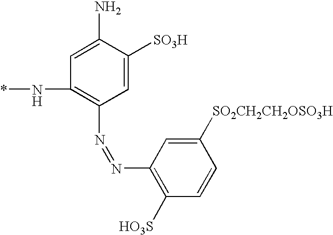 | Orange |
| Prep. Ex. 28 | 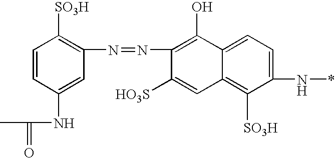 | F | 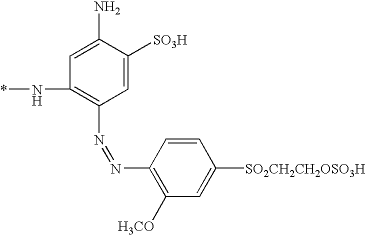 | Orange |
| Prep. Ex. 29 | 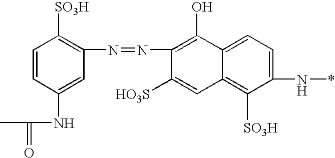 | F | 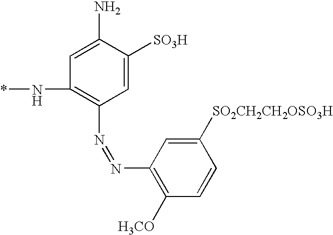 | Orange |
| Prep. Ex. 30 | 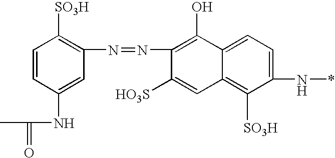 | F | 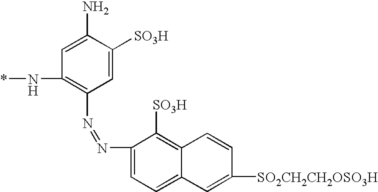 | Orange |
| Prep. Ex. 31 | 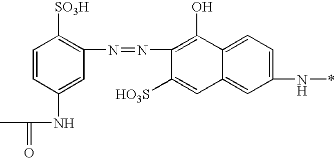 | Cl | 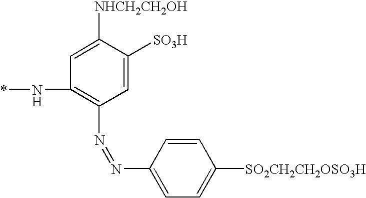 | Orange |
| Prep. Ex. 32 | 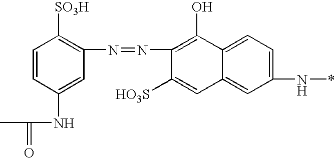 | Cl | 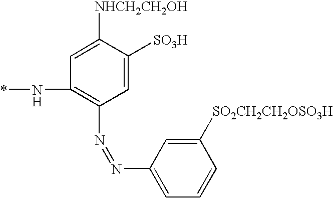 | Orange |
| Prep. Ex. 33 | 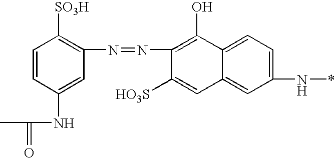 | Cl | 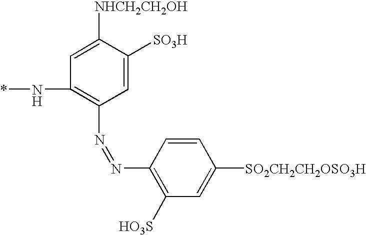 | Orange |
| Prep. Ex. 34 | 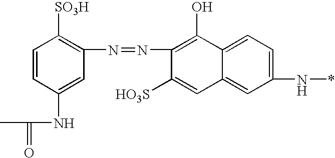 | Cl | 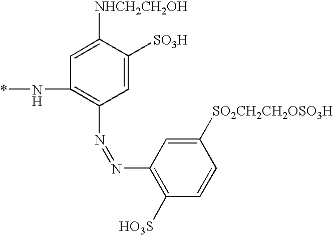 | Orange |
| Prep. Ex. 35 | 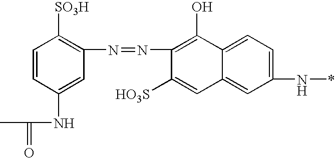 | Cl | 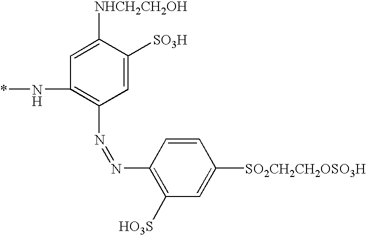 | Orange |
| Prep. Ex. 36 | 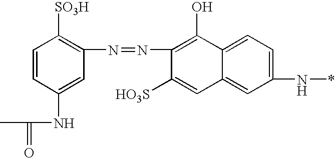 | Cl | 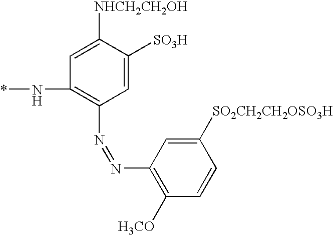 | Orange |
| Prep. Ex. 37 | 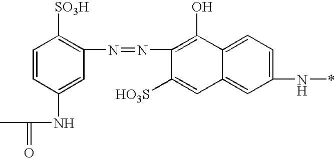 | Cl | 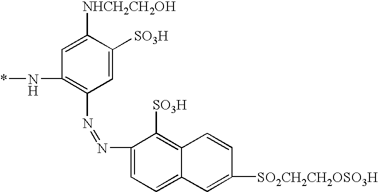 | Orange |
| Prep. Ex. 38 | 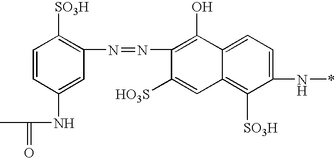 | Cl | 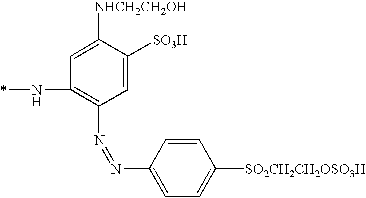 | Orange |
| Prep. Ex. 39 | 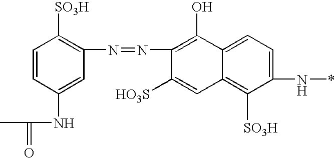 | Cl | 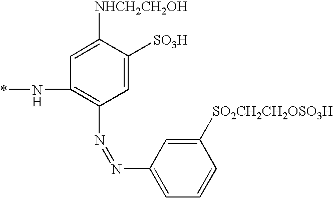 | Orange |
| Prep. Ex. 40 | 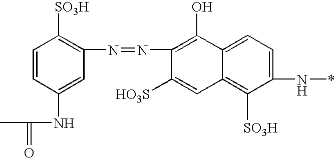 | Cl | 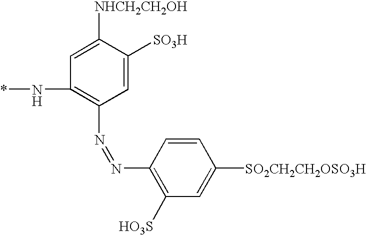 | Orange |
| Prep. Ex. 41 | 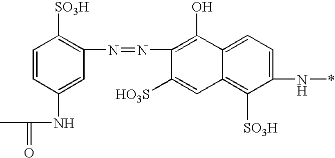 | Cl | 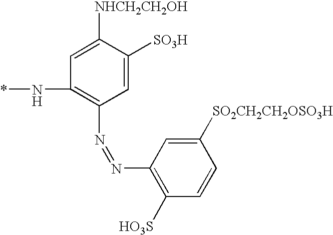 | Orange |
| Prep. Ex. 42 | 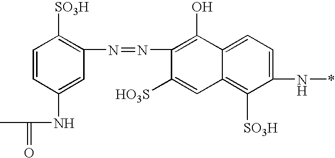 | Cl | 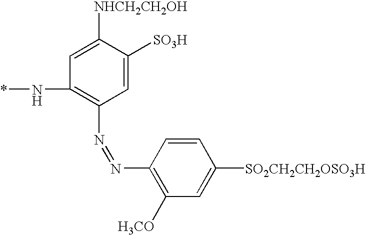 | Orange |
| Prep. Ex. 43 | 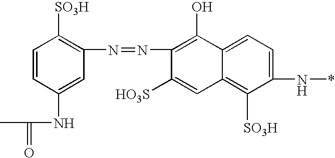 | Cl | 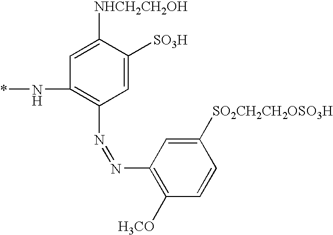 | Orange |
| Prep. Ex. 44 | 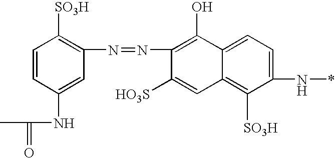 | Cl | 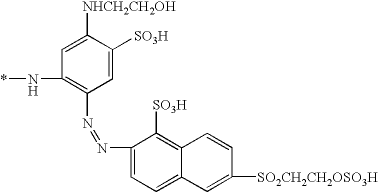 | Orange |
| Prep. Ex. 45 | 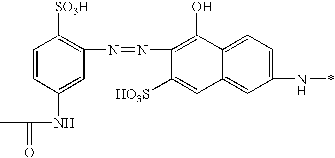 | F | 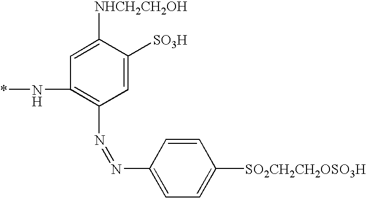 | Orange |
| Prep. Ex. 46 | 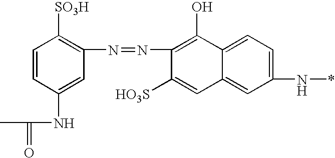 | F | 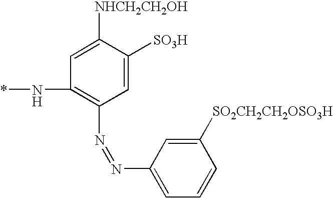 | Orange |
| Prep. Ex. 47 | 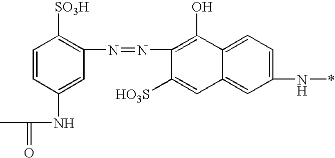 | F | 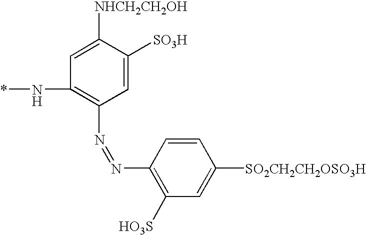 | Orange |
| Prep. Ex. 48 | 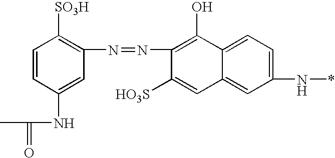 | F | 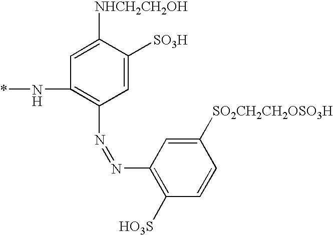 | Orange |
| Prep. Ex. 49 | 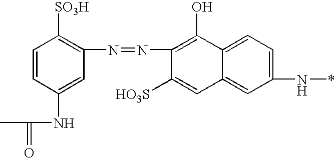 | F | 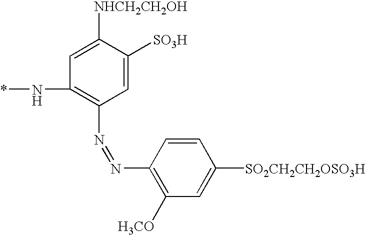 | Orange |
| Prep. Ex. 50 | 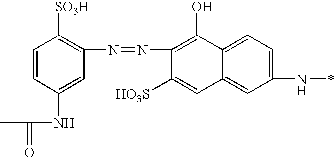 | F | 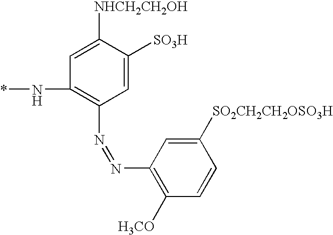 | Orange |
| Prep. Ex. 51 | 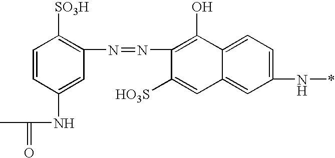 | F | 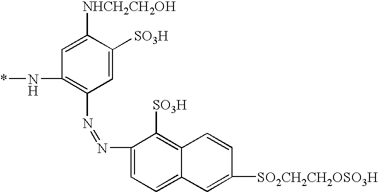 | Orange |
| Prep. Ex. 52 | 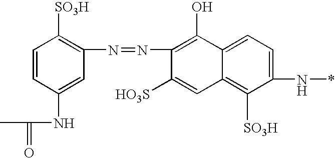 | F | 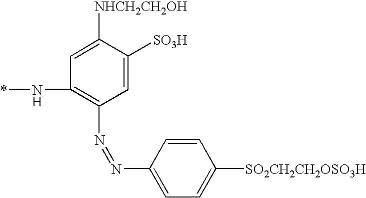 | Orange |
| Prep. Ex. 53 | 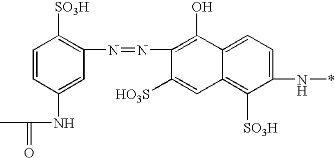 | F | 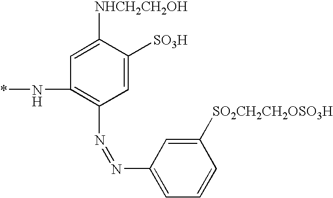 | Orange |
| Prep. Ex. 54 | 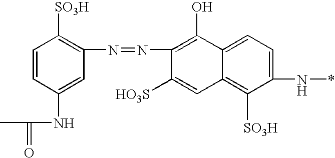 | F | 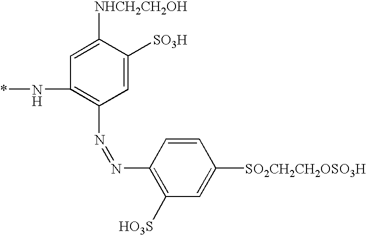 | Orange |
| Prep. Ex. 55 | 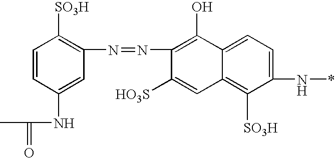 | F | 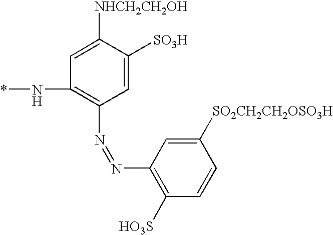 | Orange |
| Prep. Ex. 56 | 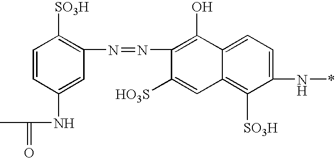 | F | 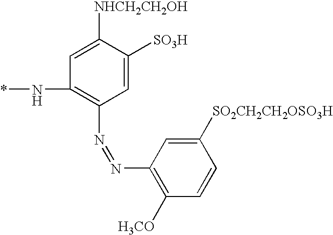 | Orange |
| Prep. Ex. 57 | 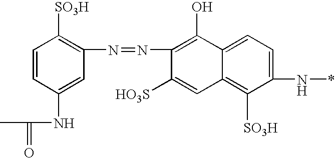 | F | 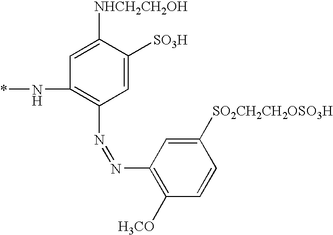 | Orange |
| Prep. Ex. 58 | 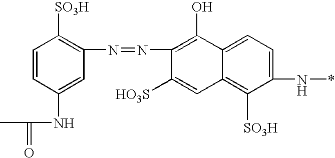 | F | 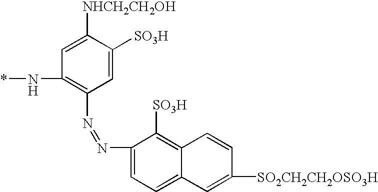 | Orange |
| Prep. Ex. 59 | 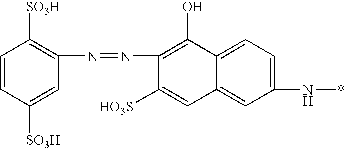 | Cl | 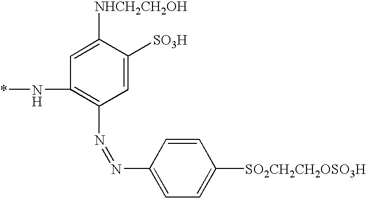 | Orange |
| Prep. Ex. 60 | 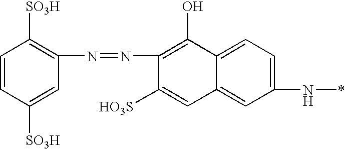 | Cl | 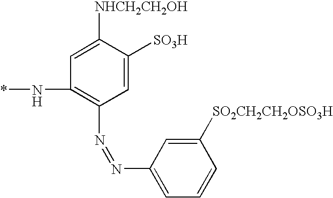 | Orange |
| Prep. Ex. 61 | 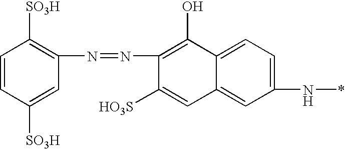 | Cl | 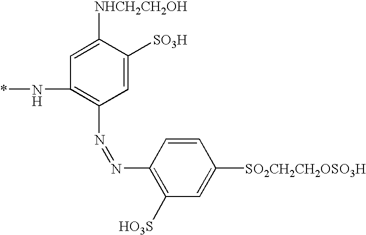 | Orange |
| Prep. Ex. 62 | 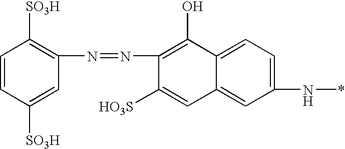 | Cl | 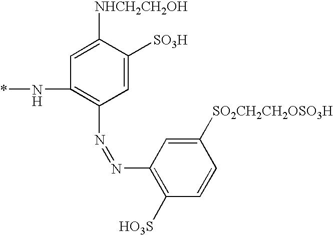 | Orange |
| Prep. Ex. 63 | 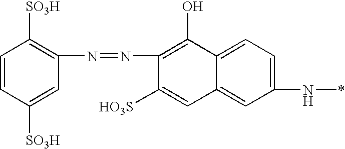 | Cl | 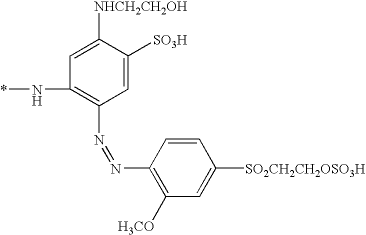 | Orange |
| Prep. Ex. 64 | 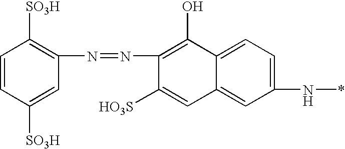 | Cl | 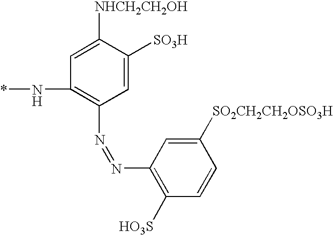 | Orange |
| Prep. Ex. 65 | 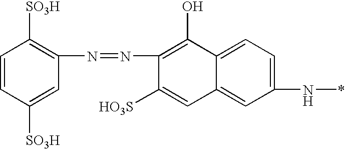 | Cl | 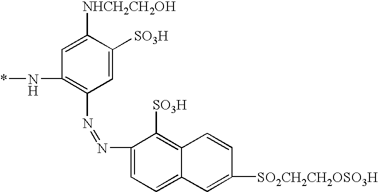 | Orange |
| Prep. Ex. 66 | 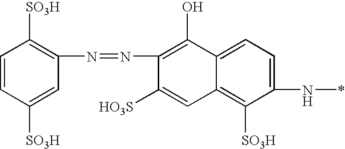 | Cl | 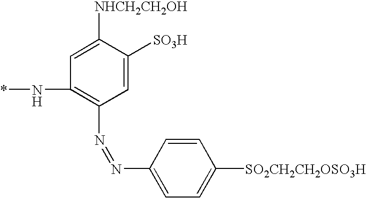 | Orange |
| Prep. Ex. 67 | 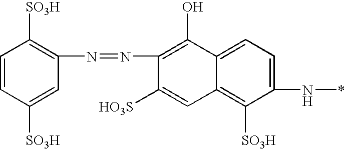 | Cl | 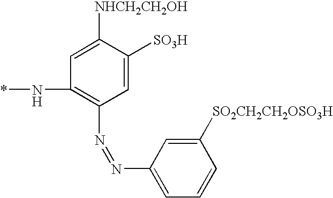 | Orange |
| Prep. Ex. 68 | 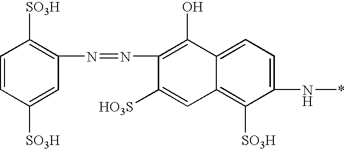 | Cl | 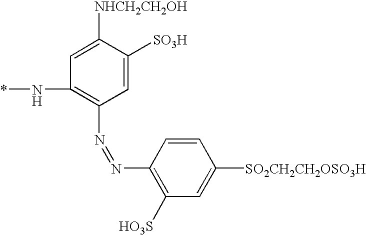 | Orange |
| Prep. Ex. 69 | 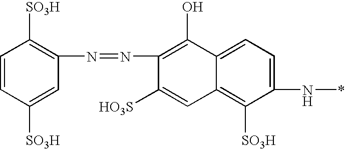 | Cl | 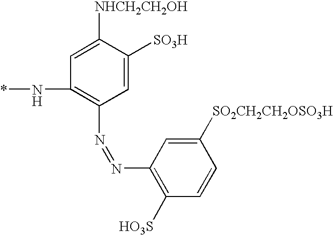 | Orange |
| Prep. Ex. 70 | 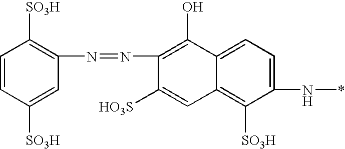 | Cl | 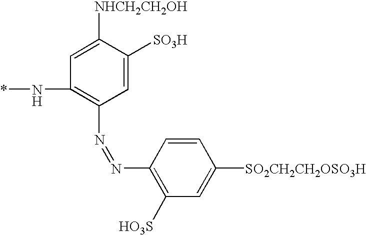 | Orange |
| Prep. Ex. 71 | 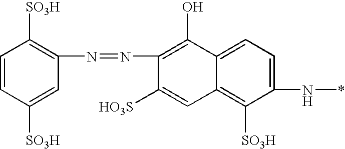 | Cl | 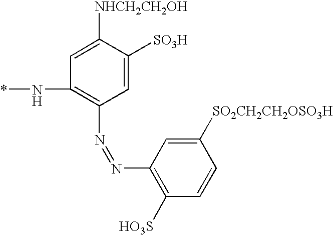 | Orange |
| Prep. Ex. 72 | 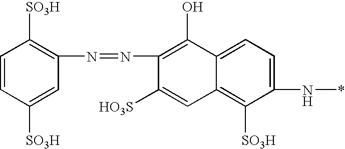 | Cl | 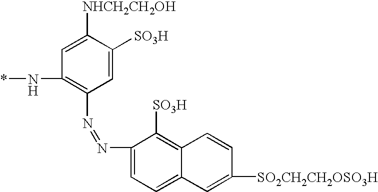 | Orange |
| Prep. Ex. 73 | 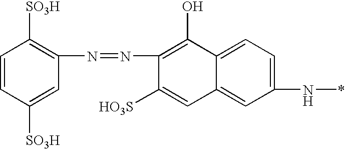 | F | 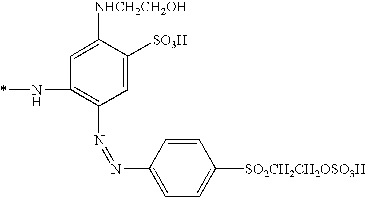 | Orange |
| Prep. Ex. 74 | 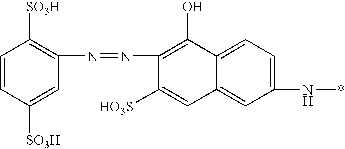 | F | 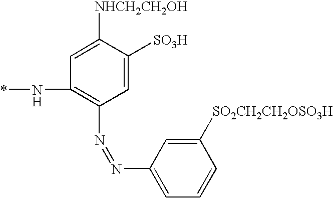 | Orange |
| Prep. Ex. 75 | 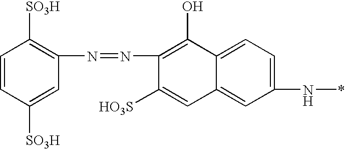 | F | 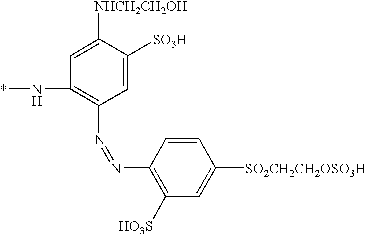 | Orange |
| Prep. Ex. 76 | 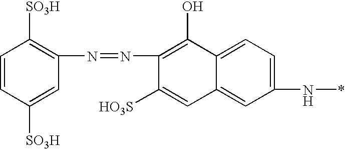 | F | 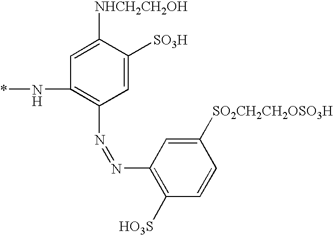 | Orange |
| Prep. Ex. 77 | 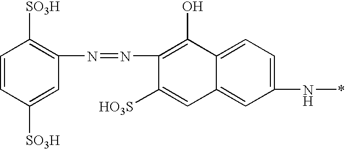 | F | 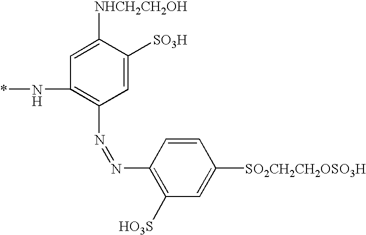 | Orange |
| Prep. Ex. 78 | 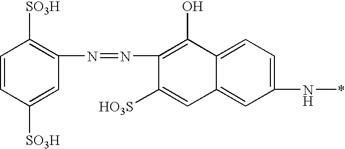 | F | 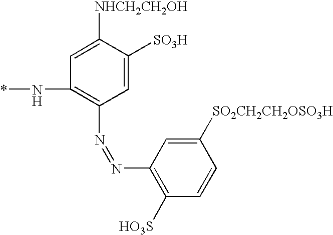 | Orange |
| Prep. Ex. 79 | 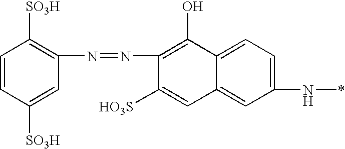 | F | 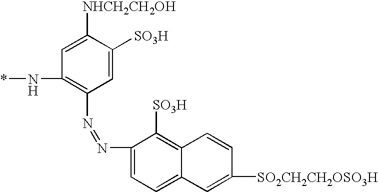 | Orange |
| Prep. Ex. 80 | 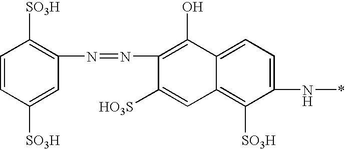 | F | 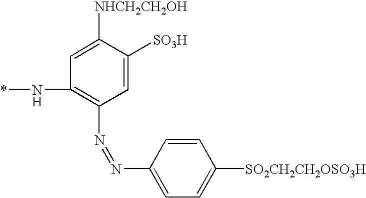 | Orange |
| Prep. Ex. 81 | 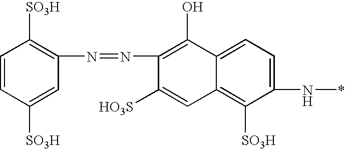 | F | 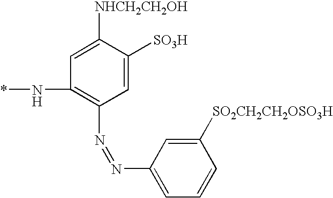 | Orange |
| Prep. Ex. 82 | 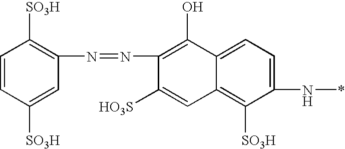 | F | 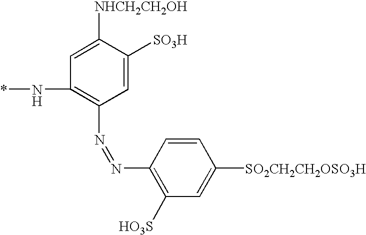 | Orange |
| Prep. Ex. 83 | 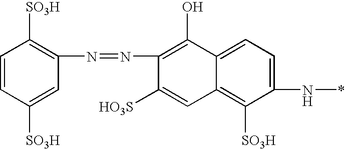 | F | 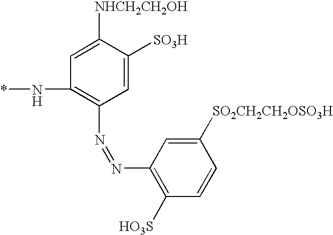 | Orange |
| Prep. Ex. 84 | 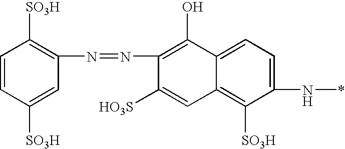 | F | 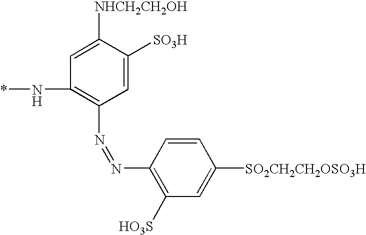 | Orange |
| Prep. Ex. 85 | 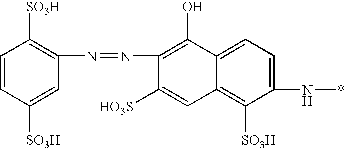 | F | 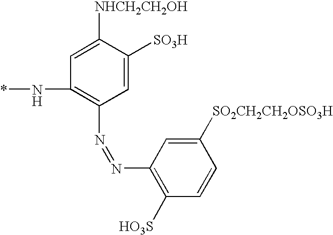 | Orange |
| Prep. Ex. 86 | 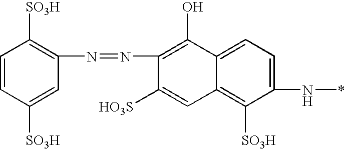 | F | 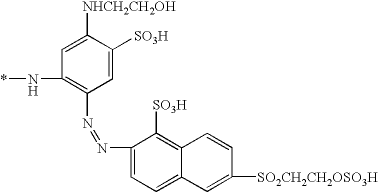 | Orange |

### Preparative Examples 87 Through 118

153 parts of 1-amino-3-ureidobenzene were dispersed in 1500 parts of water and then the resulting dispersion was neutralized to pH 7 using a 25% aqueous solution of sodium hydroxide. 383 parts of 2-amino-3,6,8-naphthyltrisulfonic acid were dispersed in 2000 parts of water and 100 parts of hydrochloric acid, and 230 parts of a 30% sodium nitrite solution was added dropwise to the resulting solution for 30 min while maintaining below 5° C. and the mixture was maintained at that temperature for 2 hours, thereby synthesizing a diazonium salt. The thus-synthesized diazonium salt was added dropwise to the 1-amino-3-ureidobenzene dispersion while maintaining below 10° C., and the resulting mixture was neutralized to pH 6.5 with a 20% aqueous solution of sodium carbonate, thereby synthesizing a first coupling product.

184.4 parts of cyanuric chloride were dispersed in 300 parts of water at 0° C., followed by addition of the first coupling product, and the resulting mixture was neutralized to pH 6.0 with a 20% aqueous solution of sodium carbonate, thereby preparing a first condensation product.

281.3 parts of 3-aminobenzene-sulfatoethyl sulfonic acid
in the form of powder was added to the first condensation product which was then neutralized to pH 6 with a 20% aqueous solution of sodium carbonate, thereby preparing a compound having the structure as shown below:

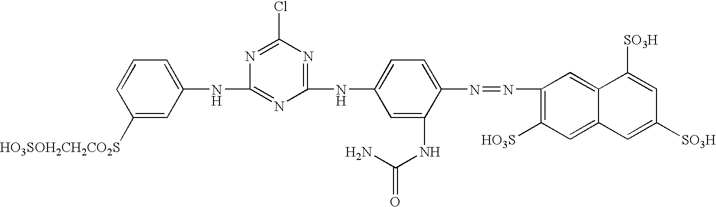

Further, based on the above procedures, it was possible to synthesize compounds listed in Table 2. A specific preparation method of these compounds can be sufficiently deduced through previous Preparative Examples based on chemical structures of the products, and thus details thereof will be omitted herein.

Compound of Formula 2

TABLE 2

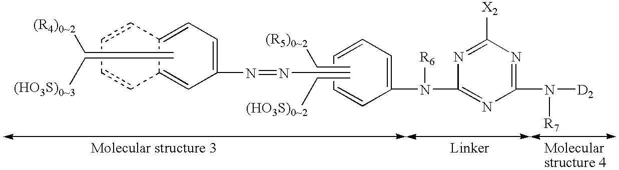

| | | Linker | | |
|---|---|---|---|---|
| No. | Molecular structure 3 | (X₂) | Molecular structure 4 | Color |
| Prep. Ex. 87 | 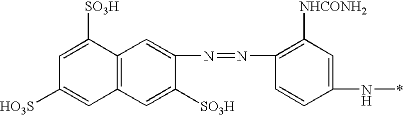 | Cl | 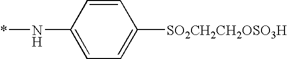 | Yellow |
| Prep. Ex. 88 | 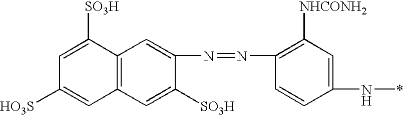 | Cl | 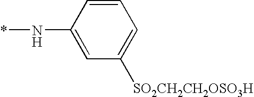 | Yellow |
| Prep. Ex. 89 | 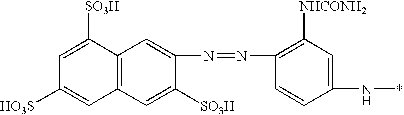 | Cl | 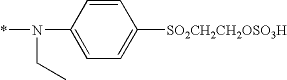 | Yellow |
| Prep. Ex. 90 | 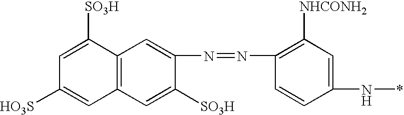 | Cl | 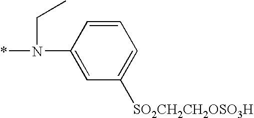 | Yellow |
| Prep. Ex. 91 | 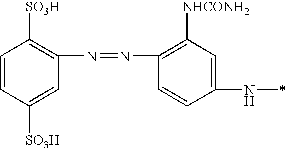 | Cl | 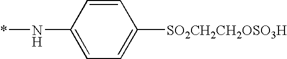 | Yellow |
| Prep. Ex. 92 | 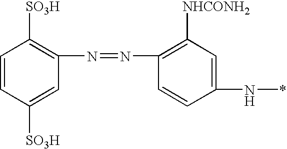 | Cl | 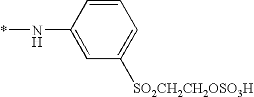 | Yellow |
| Prep. Ex. 93 | 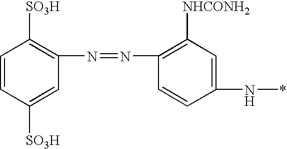 | Cl | 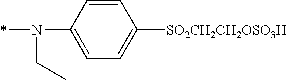 | Yellow |
| Prep. Ex. 94 | 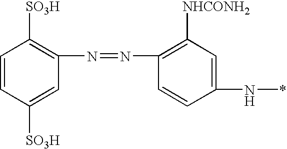 | Cl | 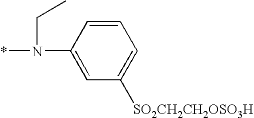 | Yellow |
| Prep. Ex. 95 | 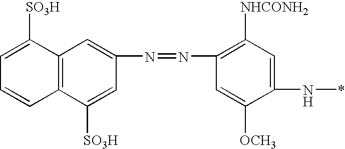 | Cl | 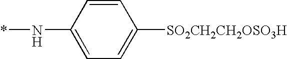 | Yellow |
| Prep. Ex. 96 | 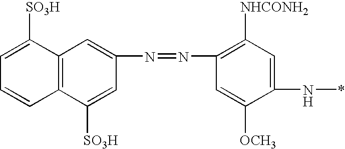 | Cl | 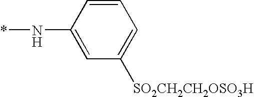 | Yellow |
| Prep. Ex. 97 | 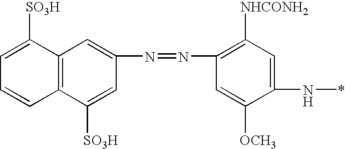 | Cl | 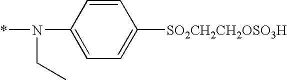 | Yellow |
| Prep. Ex. 98 | 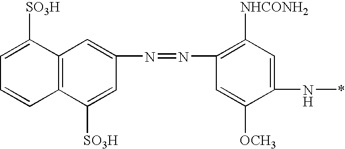 | Cl | 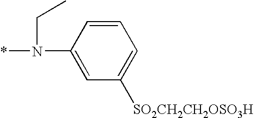 | Yellow |
| Prep. Ex. 99 | 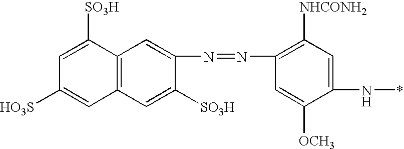 | Cl | 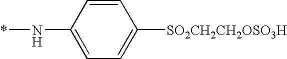 | Yellow |
| Prep. Ex. 100 | 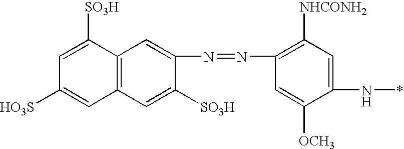 | Cl | 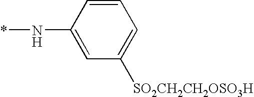 | Yellow |
| Prep. Ex. 101 | 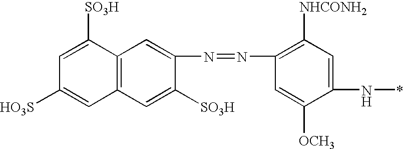 | Cl | 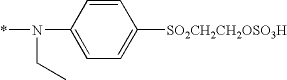 | Yellow |
| Prep. Ex. 102 | 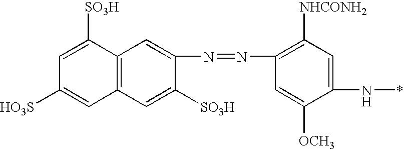 | Cl | 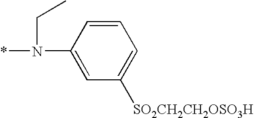 | Yellow |
| Prep. Ex. 103 | 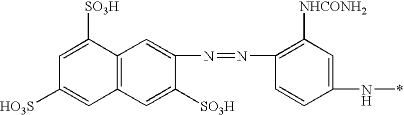 | F | 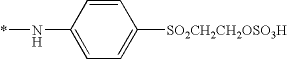 | Yellow |
| Prep. Ex. 104 | 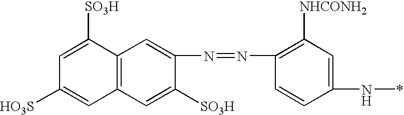 | F | 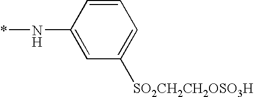 | Yellow |
| Prep. Ex. 105 | 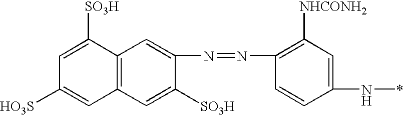 | F | 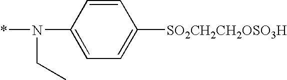 | Yellow |
| Prep. Ex. 106 | 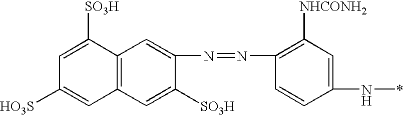 | F | 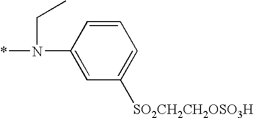 | Yellow |
| Prep. Ex. 107 | 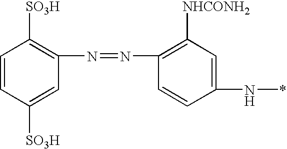 | F | 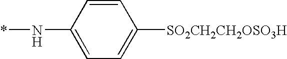 | Yellow |
| Prep. Ex. 108 | 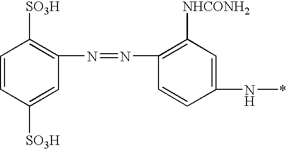 | F | 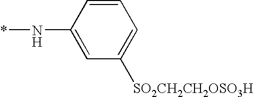 | Yellow |
| Prep. Ex. 109 | 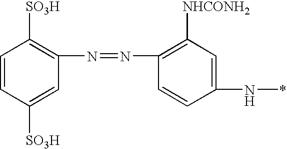 | F | 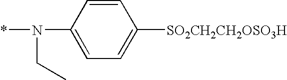 | Yellow |
| Prep. Ex. 110 | 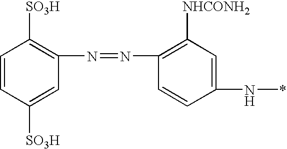 | F | 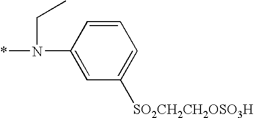 | Yellow |
| Prep. Ex. 111 | 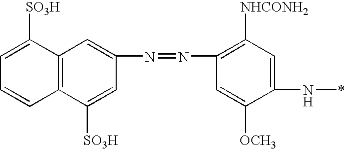 | F | 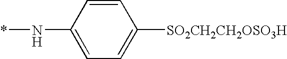 | Yellow |
| Prep. Ex. 112 | 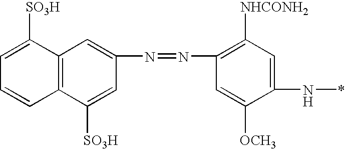 | F | 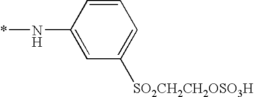 | Yellow |
| Prep. Ex. 113 | 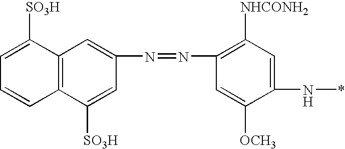 | F | 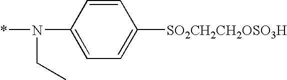 | Yellow |
| Prep. Ex. 114 | 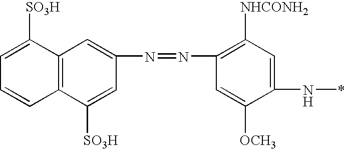 | F | 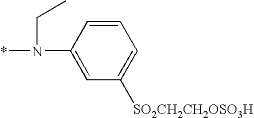 | Yellow |
| Prep. Ex. 115 | 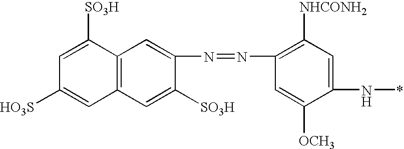 | F | 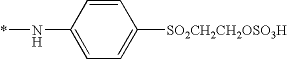 | Yellow |
| Prep. Ex. 116 | 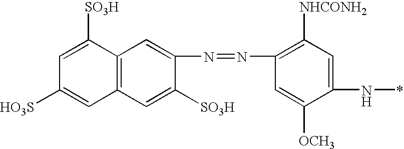 | F | 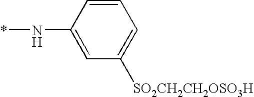 | Yellow |
| Prep. Ex. 117 | 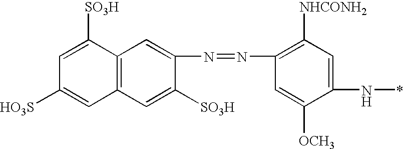 | F | 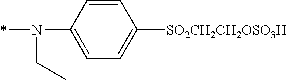 | Yellow |
| Prep. Ex. 118 | 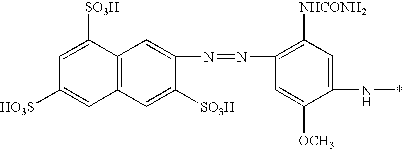 | F | 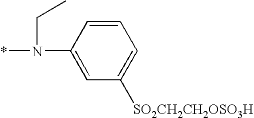 | Yellow |

### Example 1

The dye mixtures produced in accordance with the present invention, when they were used according to the following dyeing method, and conventional application and fixing methods, were yellow and orange dyed on cellulose fibers, and exhibited high-light fastness and wash fastness.

Hereinafter, dyeing methods 1 and 2 and a printing method to confirm physical properties of dyed products will be described.

(1) Dyeing Method 1

1.0 g of the compound of Preparative Example 12 and 1.0 g of the compound of Preparative Example 88 were mixed and dissolved in 400 g of water. The resulting solution was added to 1,500 g of a solution containing 53 g/L of sodium chloride, thereby preparing a dye bath. 100 g of a cotton fabric was added at 40° C. to the dye bath, and 100 g of a solution containing 16 g/L of sodium hydroxide and 20 g of calcined sodium carbonate was added after 45 min. Additionally, the temperature of the dye bath was maintained at 40° C. for 45 min. Next, the dyed fabric was rinsed, soaped with a nonionic detergent for 25 min upon bubbling, and then rinsed again and dried.

(2) Dyeing Method 2

1.0 g of the compound of Preparative Example 12 and 1.0 g of the compound of Preparative Example 88 were mixed and dissolved in 400 g of water. The resulting solution was added to 1,500 g of a solution containing 53 g/L of sodium chloride, thereby preparing a dye bath. 100 g of a cotton fabric was added at 35° C. to the dye bath, and 20 min later, 100 g of a solution containing 16 g/L of sodium hydroxide and 20 g of calcined sodium carbonate was added thereto. Additionally, the temperature of the dye bath was maintained at 35° C. for 15 min. Then, the temperature of the dye bath was elevated 60° C. over 20 min, and was additionally maintained at that temperature for 35 min. Thereafter, the dyed fabric was rinsed, soaped with a nonionic detergent for 25 min upon bubbling, and then rinsed again and dried.

(3) Printing Method

5.0 g of the compound of Preparative Example 12 and 5.0 g of the compound of Preparative Example 88 were mixed and dispersed in 100 g of a stock thickening solution containing 50 g of a sodium alginate thickener, 27.8 g of water, 20 g of urea and 1.2 g of sodium m-nitrobenzene sulfonate while vigorously stirring, thereby obtaining a printing paste. A cotton fabric was printed with the printing paste and dried. The printed cotton fabric was steamed in saturated steam at 102° C. for 2 min, rinsed, and if necessary, soaped upon bubbling, and rinsed and dried once more.

### Example 2

The dye mixtures produced in accordance with the present invention, when they were used according to the following dyeing method, and conventional application and fixing methods, were orange dyed on cellulose fibers, and exhibited high-light fastness and wash fastness.

Hereinafter, dyeing methods 1 and 2 and a printing method to confirm physical properties of dyed products will be described.

(1) Dyeing Method 1

1.0 g of the compound of Preparative Example 31 and 1.0 g of the compound of Preparative Example 88 were mixed and dissolved in 400 g of water. The resulting solution was added to 1,500 g of a solution containing 53 g/L of sodium chloride, thereby preparing a dye bath. 100 g of a cotton fabric was added at 40° C. to the dye bath, and 100 g of a solution containing 16 g/L of sodium hydroxide and 20 g of calcined sodium carbonate was added after 45 min. Additionally, the temperature of the dye bath was maintained at 40° C. for 45 min. Next, the dyed fabric was rinsed, soaped with a nonionic detergent for 25 min upon bubbling, and then rinsed again and dried.

(2) Dyeing Method 2

1.0 g of the compound of Preparative Example 31 and 1.0 g of the compound of Preparative Example 88 were mixed and dissolved in 400 g of water. The resulting solution was added to 1,500 g of a solution containing 53 g/L of sodium chloride, thereby preparing a dye bath. 100 g of a cotton fabric was added at 35° C. to the dye bath, and 20 min later, 100 g of a solution containing 16 g/L of sodium hydroxide and 20 g of calcined sodium carbonate was added thereto. Additionally, the temperature of the dye bath was maintained at 35° C. for 15 min. Then, the temperature of the dye bath was elevated 60° C. over 20 min, and was further maintained at that temperature for 35 min. Thereafter, the dyed fabric was rinsed, soaped with a nonionic detergent for 25 min upon bubbling, and then rinsed again and dried.

(3) Printing Method

5.0 g of the compound of Preparative Example 31 and 5.0 g of the compound of Preparative Example 88 were mixed and dispersed in 100 g of a stock thickening solution containing 50 g of a sodium alginate thickener, 27.8 g of water, 20 g of urea and 1.2 g of sodium m-nitrobenzene sulfonate while vigorously stirring, thereby obtaining a printing paste. A cotton fabric was printed with the printing paste and dried. The printed cotton fabric was steamed in saturated steam, at 102° C. for 2 min, rinsed, and if necessary, soaped upon bubbling, and rinsed and dried once more.

### Example 3

The dye mixtures produced in accordance with the present invention, when they were used according to the following dyeing method, and conventional application and fixing methods, were orange dyed on cellulose fibers, and exhibited high-light fastness and wash fastness.

Hereinafter, dyeing methods 1 and 2 and a printing method to confirm physical properties of dyed products will be described.

(1) Dyeing Method 1

1.0 g of the compound of Preparative Example 39 and 1.0 g of the compound of Preparative Example 88 were mixed and dissolved in 400 g of water. The resulting solution was added to 1,500 g of a solution containing 53 g/L of sodium chloride, thereby preparing a dye bath. 100 g of a cotton fabric was added at 40° C. to the dye bath, and 100 g of a solution containing 16 g/L of sodium hydroxide and 20 g of calcined sodium carbonate was added after 45 min. Additionally, the temperature of the dye bath was maintained at 40° C. for 45 min. Next, the dyed fabric was rinsed, soaped with a nonionic detergent for 25 min upon bubbling, and then rinsed again and dried.

(2) Dyeing Method 2

1.0 g of the compound of Preparative Example 39 and 1.0 g of the compound of Preparative Example 88 were mixed and dissolved in 400 g of water. The resulting solution was added to 1,500 g of a solution containing 53 g/L of sodium chloride, thereby preparing a dye bath. 100 g of a cotton fabric was added at 35° C. to the dye bath, and 20 min later, 100 g of a solution containing 16 g/L of sodium hydroxide and 20 g of calcined sodium carbonate was added thereto. Additionally, the temperature of the dye bath was maintained at 35° C. for 15 min. Then, the temperature of the dye bath was elevated 60° C. over 20 min, and was further maintained at that temperature for 35 min. Thereafter, the dyed fabric was rinsed, soaped with a nonionic detergent for 25 min upon bubbling, and then rinsed again and dried.

(3) Printing Method

5.0 g of the compound of Preparative Example 39 and 5.0 g of the compound of Preparative Example 88 were mixed and dispersed in 100 g of a stock thickening solution containing 50 g of a sodium alginate thickener, 27.8 g of water, 20 g of urea and 1.2 g of sodium m-nitrobenzene sulfonate while vigorously stirring, thereby obtaining a printing paste. A cotton fabric was printed with the printing paste and dried. The printed cotton fabric was steamed in saturated steam at 102° C. for 2 min, rinsed, and if necessary, soaped upon bubbling, and rinsed and dried once more.

### Example 4

Using compounds prepared in Preparative Examples, dyeing with the dye mixtures was carried out in the same manner as in Example 1. Specific structures and colors of the compounds used are shown in Tables 1 and 2, and specific details of compound combinations and mixing ratios thereof, and the colors obtained by dyeing are shown in Table 3.

TABLE 3

| | | | Ratio of Compound | |
|---|---|---|---|---|
| No. | Compound 1 | Compound 2 | 1:Compound 2 | Color |
| Mixture 1 | Prep. Ex. 12 | Prep. Ex. 88 | 10:90 | Yellow |
| Mixture 2 | Prep. Ex. 12 | Prep. Ex. 88 | 20:80 | Yellow |
| Mixture 3 | Prep. Ex. 12 | Prep. Ex. 88 | 30:70 | Yellow |
| Mixture 4 | Prep. Ex. 12 | Prep. Ex. 88 | 40:60 | Yellow |
| Mixture 5 | Prep. Ex. 12 | Prep. Ex. 88 | 50:50 | Yellow |
| Mixture 6 | Prep. Ex. 12 | Prep. Ex. 88 | 60:40 | Yellow |
| Mixture 7 | Prep. Ex. 12 | Prep. Ex. 88 | 70:30 | Orange |
| Mixture 8 | Prep. Ex. 12 | Prep. Ex. 88 | 80:20 | Orange |
| Mixture 9 | Prep. Ex. 12 | Prep. Ex. 88 | 90:10 | Orange |
| Mixture 10 | Prep. Ex. 31 | Prep. Ex. 88 | 10:90 | Yellow |
| Mixture 11 | Prep. Ex. 31 | Prep. Ex. 88 | 20:80 | Yellow |
| Mixture 12 | Prep. Ex. 31 | Prep. Ex. 88 | 30:70 | Yellow |
| Mixture 13 | Prep. Ex. 31 | Prep. Ex. 88 | 40:60 | Yellow |
| Mixture 14 | Prep. Ex. 31 | Prep. Ex. 88 | 50:50 | Yellow |
| Mixture 15 | Prep. Ex. 31 | Prep. Ex. 88 | 60:40 | Yellow |
| Mixture 16 | Prep. Ex. 31 | Prep. Ex. 88 | 70:30 | Orange |
| Mixture 17 | Prep. Ex. 31 | Prep. Ex. 88 | 80:20 | Orange |
| Mixture 18 | Prep. Ex. 31 | Prep. Ex. 88 | 90:10 | Orange |
| Mixture 19 | Prep. Ex. 39 | Prep. Ex. 88 | 10:90 | Yellow |
| Mixture 20 | Prep. Ex. 39 | Prep. Ex. 88 | 20:80 | Yellow |
| Mixture 21 | Prep. Ex. 39 | Prep. Ex. 88 | 30:70 | Yellow |
| Mixture 22 | Prep. Ex. 39 | Prep. Ex. 88 | 40:60 | Yellow |
| Mixture 23 | Prep. Ex. 39 | Prep. Ex. 88 | 50:50 | Yellow |
| Mixture 24 | Prep. Ex. 39 | Prep. Ex. 88 | 60:40 | Yellow |
| Mixture 25 | Prep. Ex. 39 | Prep. Ex. 88 | 70:30 | Orange |
| Mixture 26 | Prep. Ex. 39 | Prep. Ex. 88 | 80:20 | Orange |
| Mixture 27 | Prep. Ex. 39 | Prep. Ex. 88 | 90:10 | Orange |
| Mixture 28 | Prep. Ex. 59 | Prep. Ex. 88 | 10:90 | Yellow |
| Mixture 29 | Prep. Ex. 59 | Prep. Ex. 88 | 20:80 | Yellow |
| Mixture 30 | Prep. Ex. 59 | Prep. Ex. 88 | 30:70 | Yellow |
| Mixture 31 | Prep. Ex. 59 | Prep. Ex. 88 | 40:60 | Yellow |
| Mixture 32 | Prep. Ex. 59 | Prep. Ex. 88 | 50:50 | Yellow |
| Mixture 33 | Prep. Ex. 59 | Prep. Ex. 88 | 60:40 | Yellow |
| Mixture 34 | Prep. Ex. 59 | Prep. Ex. 88 | 70:30 | Orange |
| Mixture 35 | Prep. Ex. 59 | Prep. Ex. 88 | 80:20 | Orange |
| Mixture 36 | Prep. Ex. 59 | Prep. Ex. 88 | 90:10 | Orange |
| Mixture 37 | Prep. Ex. 66 | Prep. Ex. 88 | 10:90 | Yellow |
| Mixture 38 | Prep. Ex. 66 | Prep. Ex. 88 | 20:80 | Yellow |
| Mixture 39 | Prep. Ex. 66 | Prep. Ex. 88 | 30:70 | Yellow |
| Mixture 40 | Prep. Ex. 66 | Prep. Ex. 88 | 40:60 | Yellow |
| Mixture 41 | Prep. Ex. 66 | Prep. Ex. 88 | 50:50 | Yellow |
| Mixture 42 | Prep. Ex. 66 | Prep. Ex. 88 | 60:40 | Yellow |
| Mixture 43 | Prep. Ex. 66 | Prep. Ex. 88 | 70:30 | Orange |
| Mixture 44 | Prep. Ex. 66 | Prep. Ex. 88 | 80:20 | Orange |
| Mixture 45 | Prep. Ex. 66 | Prep. Ex. 88 | 90:10 | Orange |

### Experimental Example

In order to confirm differences in physical properties exhibited upon dyeing, using dye mixtures in accordance with the present invention, conventional dye compounds and single dyes, dyeability experiments were performed as follows.

1. K/S Value Per Dyeing Concentration

Absolute color values were determined using a colorimeter, called a Computer Color Matching (CCM) system, and dyeability and color coordinate were determined according to absorption of light emitted from the instrument. Here, a difference of dyeability can be confirmed by comparing a K/S value, a value which is obtained by a numerical expression of changes occurred by absorption (absorption coefficient, K) and reflection (scattering coefficient, S) of a light source.

2. Details of Experiment

A dye solution, which was prepared by adding 0.6 g of a dye (or dye mixture) to 1,200 mL of water, was placed a 2L stainless beaker, and ⅓ Common Salt, ¼ Soda Ash and 1 g/L of a leveling agent were added thereto and stirred. Then, cotton knit, moistened with water, was tightly wrung and introduced into the beaker. In performing the experiment, it should be careful that none of the cotton knit is exposed outside the dye solution. 15 min after staring dyeing, ⅓ Common Salt was added, and 15 min later ¾ Soda Ash was added. Then, the cloth was dyed for 45 to 60 min while maintaining the temperature of the dye solution at a range of 98 to 100° C. After dyeing was complete, the dyed cloth was cold rinsed, and 0.5 g/L of a soaping agent and 1.0 g/L of Soda Ash were added, followed by soaping at a temperature of 40 to 45° C. for 10 min. The dyed cloth was cold rinsed again, dehydrated and dried at 60° C. The K/S value of the thus-obtained dyed product was measured using a CCM system.

(3) Experimental Results

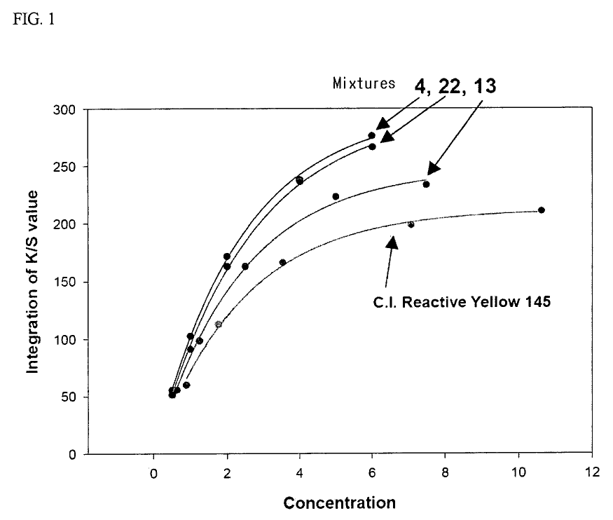

As can be seen from FIG. 1, the dye mixtures in accordance with the present invention exhibited a higher K/S value than C.I. Reactive Yellow 145, thus representing that the dye mixtures in accordance with the present invention have superior build-up properties.

As apparent from the above description, the dye mixture in accordance with the present invention exhibits superior build-up property, dyeing levelness and washability, upon dyeing of a fiber material, particularly a cellulose fiber, and also has excellent fastness in light fastness, wash fastness, chlorine fastness and sweat fastness of a dyed product. In particular, as compared to an amount of an inorganic salt used in conventional arts, use of a smaller amount of the inorganic salt, which is added upon dyeing, can provide superior dyeability, and very high reproducibility in dip-dyeing and printing dyeing. Superior build-up properties of the dye in a dyestuff area mean that the dye has excellent properties capable of maintaining color appearance for an extended period of time due to high dyeability. Further, as described above, the dye mixture in accordance with the present invention produces a lower amount of an inorganic salt, thus reducing wastewater treatment costs and is also environmentally friendly.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A reactive dye mixture, comprising
(i) one or more reactive dyes represented by Formula 1, and
(ii) one or more reactive dyes represented by Formula 2: 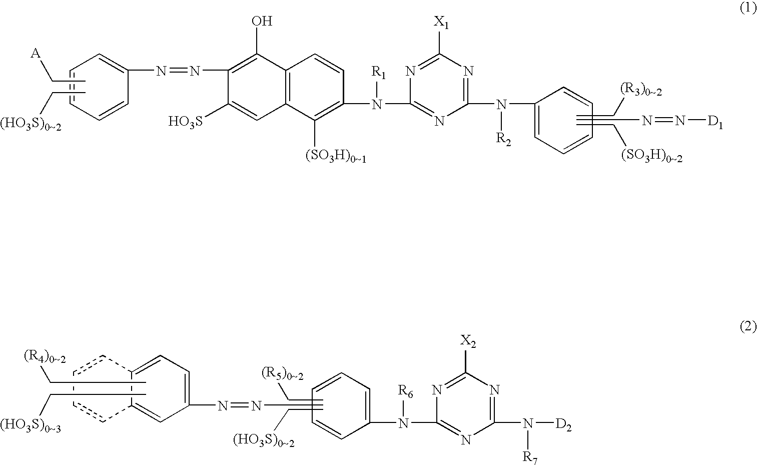
wherein:
R₁, R₂, R₆ and R₇ are independently hydrogen or C₁-C₄ alkyl, 2-hydroxyethyl, 2-chloroethyl, or 2-fluoroethyl group;
R₃, R₄ and R₅ are independently hydrogen, sulfo, C₁-C₄ alkyl, C₁-C₄ alkoxy, hydroxyl, halogen, unsubstituted or C₁-C₄ alkyl substituted amino, phenylamino, acetylamino, C₂-C₄ alkanoylamino, benzoylamino, or ureido group;
A is a substituent group of 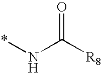
wherein R₈ is C₁-C₄ alkyl, unsubstituted or substituted phenyl, the substituted phenyl including nitro-substituted phenyl and cyano-substituted phenyl, or an amino group;
X₁ and X₂ are independently halogen, hydroxyl, unsubstituted or substituted amino, unsubstituted or C₁-C₄ alkyl substituted phenylamino, unsubstituted or carbamoyl or carboxy substituted pyridinyl, morpholino, or an N-heterocyclic group further containing a hetero atom;
D₁ is a substituent group of 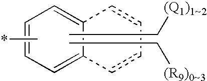
wherein R₉ is hydrogen, sulfo, C₁-C₄ alkyl, C₁-C₄ alkoxy, halogen, 2-hydroxyethyl, 2-chloroethyl, or 2-fluoroethyl group; and Q₁ is a radical of —SO₂-Z or —CONH—(CH₂)ᵣ—SO₂-Z, wherein Z is vinyl or a radical of —CH₂—CH₂—Y, Y being a leaving group, and r is an integer from 1 to 6; and
D₂ is a substituent group of 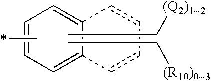
or
*—(CH₂)_{1˜4}-Q₃ wherein R₁₀ is hydrogen, sulfo, C₁-C₄ alkyl, C₁-C₄ alkoxy, halogen, 2-hydroxyethyl, 2-chloroethyl or 2-fluoroethyl group; and Q₂ and Q₃ are independently a radical of —SO₂-Z or —CONH—(CH₂)ᵣ—SO₂-Z, wherein Z is vinyl or a radical of —CH₂—CH₂—Y, Y being a leaving group (for example, —Cl, —Br, —F, —OSO₃H, —SSO₃H, —OCO—CH₃, —OPO₃H₂, —OCO—C₆H₅, —OSO₂—C₁-C₄ alkyl or —OSO₂—N(C₁-C₄ alkyl)₂), and r is an integer from 1 to 6.

2. The reactive dye mixture according to claim 1, wherein R₁, R₂, R₆ and R₇ are independently hydrogen.

3. The reactive dye mixture according to claim 1, wherein A is acetylamide or phenylamide having the structure:

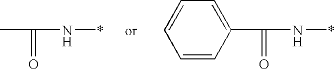

4. The reactive dye mixture according to claim 1, wherein X₁ and X₂ are fluorine or chlorine.

5. The reactive dye mixture according to claim 1, wherein Y is chlorine (—Cl) or sulfonic acid (—SO₃H).

6. The reactive dye mixture according to claim 1, wherein the compound of Formula 1 is a compound having the structure:

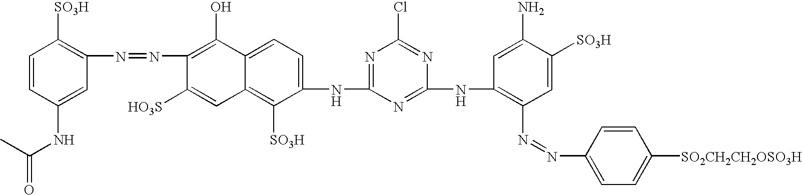

7. The reactive dye mixture according to claim 1, wherein the compound of Formula 1 is a compound having the structure:

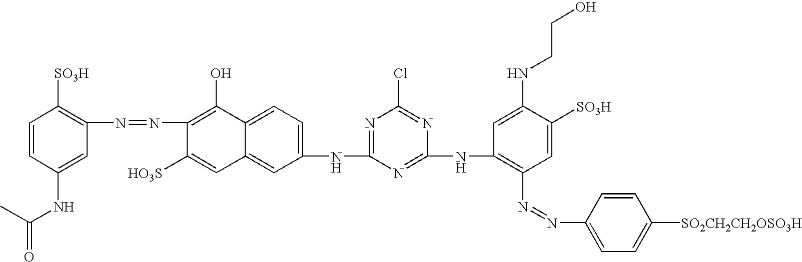

8. The reactive dye mixture according to claim 1, wherein the compound of Formula 2 is a compound represented by Formula 2a: 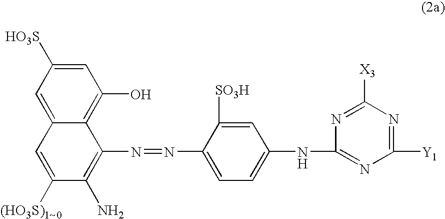
wherein:
X₃ is halogen, hydroxyl, 3-carboxypyridin-1-yl, 3-carbamoylpyridin-1-yl, C₁-C₄ alkoxy, C₁-C₄ alkylthio, unsubstituted or substituted amino, an N-heterocyclic group further containing a hetero atom, or a substituent: 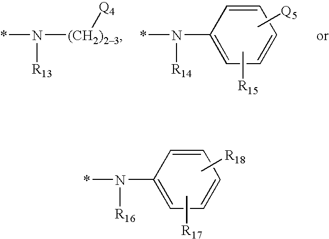
wherein R₁₃, R₁₄, R₁₅, R₁₆, R₁₇ and R₁₈ are as defined for R₃ in Formula 2, and Q₄ and Q₅ are as defined for Q₃ in Formulae 1 and 2; and
Y₁ is a substituent of 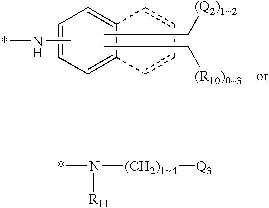
wherein Q₂, Q₃ and R₁₀ are as defined in Formula 2, and R₁₁ is hydrogen or a C₁-C₄ alkyl group.

9. The reactive dye mixture according to claim 1, wherein the compound of Formula 2 is a compound having the structure:

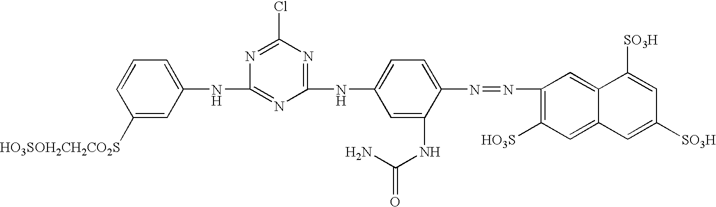

10. The reactive dye mixture according to claim 1, wherein the compound of Formula 1 is contained in an amount of 5 to 95% by weight, based on the total weight of the dye mixture.

11. A method of dyeing a fiber material containing nitrogen or hydroxyl group using the reactive dye mixture according to claim 1.
